(19) United States
(12) Patent Application Publication
(10) Pub. No.: US 2015/0206071 A1
(43) Pub. Date: Jul. 23, 2015

(54) INFORMATION PROCESSING APPARATUS, INFORMATION PROCESSING METHOD AND INFORMATION PROCESSING PROGRAM

(71) Applicant: Rakuten, Inc., Tokyo (JP)

(72) Inventor: Ryohei Takuma, Tokyo (JP)

(73) Assignee: Rakuten, Inc., Shinagawa-ku, Tokyo (JP)

(21) Appl. No.: 14/420,697

(22) PCT Filed: Mar. 19, 2013
(86) PCT No.: PCT/JP2013/057844

§ 371 Date: Feb. 10, 2015

(51) Int. Cl. G06Q 10/02; G06Q 10/10

(52) U.S. Cl. CPC G06Q 10/02; G06Q 10/1095

(57) ABSTRACT

An information processing apparatus acquires the number of users reserving reservation frames. When the number of users in a first reservation frame is smaller than the minimum number of users, the apparatus searches for a second reservation frame in which a total amount of this number of users and the number of at least part of the users reserving the first reservation frame is equal to or larger than the minimum number of users, from among reservation frames in which the number of users is smaller than the maximum number of users. The apparatus outputs information of giving a user reserving a reservation frame, which is the first or second reservation frame, and in which the number of users is smaller than the minimum number of users, a proposal to change the reservation to the other of the first reservation frame and the second reservation frame.

### TECHNICAL FIELD

The present invention relates to a technical field of a system which enables reservation of a reservation frame in which there has been set the minimum number of participants by which an event can be held, with the smaller number of people than the minimum number of participants.

### BACKGROUND ART

There has conventionally been known a technique that enables reservation of a reservation frame at which the event in which there is preset the minimum number of participants by which an event can be held, with a unit of the smaller number of people than the minimum number of participants. For example, Patent Document 1 discloses a technique for reservation of a golf course. More specifically, a reservation for a single member is permitted to be registered.

### CITATION LIST

### Patent Document

Patent Document 1: Japanese Patent Provisional Publication No. 2012-138003

### SUMMARY OF INVENTION

### Technical Problem

When reservations the number of which is equal to or larger than the minimum number of participants by which an event of golf can be held are collected by a predetermined date and time of determination of the event, the event becomes definitive. On the other hand, when the number of people does not reach the minimum number of participants by which the event can be held, the accepted reservation is automatically cancelled (see FIG. 3 of Patent Document 1). However, when the reservation is automatically cancelled, a user having made the reservation will lose the chance to participate in the event, despite setting their schedule to participate in the event.

An object of the present invention, which was made in view of the above-described problems, is to provide an information processing apparatus, information processing method and an information processing program which can reduce the risk that a reservation is automatically cancelled by failure in collecting finally users the number of whom is equal to or larger than the minimum number of users.

### Solution to Problem

In order to solve the above problem, the invention according to claim 1 is an information processing apparatus comprising: a number-of-users-acquisition means that acquires, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search means that when reservation frames which are reserved include a first reservation frame in which the number of users acquired by the number-of-users-acquisition means is smaller than the minimum number of users, searches for a second reservation frame in which the number of users acquired by the number-of-users-acquisition means is smaller than the maximum number of users and a total amount of the number of users reserving the second reservation frame and a number of at least part of the users reserving the first reservation frame is equal to or larger than the minimum number of users, from among the reservation frames which are reserved; an identification information acquisition means that when the second reservation frame is found by the search means, acquires, from a storage means that stores identification information for identifying a user in association with a reservation frame reserved by the user, identification information of a user reserving a reservation frame which is any one of the first reservation frame and the second reservation frame, the number of users of the any one acquired by the number-of-users-acquisition means being smaller than the minimum number of users of the any one; and an output means that outputs, based on the identification information acquired by the identification information acquisition means, information of giving the user identified by the identification information a proposal to change the reservation to a reservation of the other, which has not been reserved by the user, of the first reservation frame and the second reservation frame.

According to the present invention, the number of users reserving the second reservation frame is smaller than the maximum number of users, and the second reservation frame is searched for so that a total amount of the number of users reserving the second reservation frame and the number of at least part of users reserving the first reservation frame is equal to or larger than the minimum number of users. When the number of users reserving the second reservation frame is equal to or larger than the minimum number of users, the user reserving the first reservation frame, which the number of users reserving is smaller than the minimum number of users, is given a proposal to change the reservation to a reservation of the second reservation frame. When the number of users reserving the second reservation frame is smaller than the minimum number of users, the user reserving any one of the first reservation frame and the second reservation frame is given a proposal to change the reservation to the other reservation frame, which has not been reserved by this user. If the number of users reserving the reservation frame reserved by change of the reservation is equal to or larger than the minimum number of users after the user who has been given the proposal to change the reservation changes it, the user who have changed the reservation can participate in the event. It is therefore possible to reduce the risk that a reservation is automatically cancelled by failure in collecting finally users the number of whom is equal to or larger than the minimum number of users.

The invention according to claim 2 is the information processing apparatus according to claim 1, wherein: the search means searches for the second reservation frame in which the number of users acquired by the number-of-users-acquisition means is smaller than the minimum number of users.

According to the present invention, the user reserving any one of the first reservation frame and the second reservation frame is given a proposal to change the reservation. When the user who was given a proposal to change the reservation changes it, the number of users reserving one of the first reservation frame and the second reservation frame is equal to or larger than the minimum number of users. It is therefore possible for all of the user who reserved the first reservation frame and the user who reserved the second reservation frame to participate in the event. In addition, the number of reservation frames to be cancelled can be reduced.

The invention according to claim 3 is the information processing apparatus according to claim 2, further comprising: a date and time acquisition means that acquires, from a date and time storage means that stores a date and time at which a user has reserved a reservation frame, a date and time at which a user has reserved the first reservation frame and a date and time at which a user has reserved the second reservation frame, and wherein: the identification information acquisition means acquires the identification information of one of which the date and time acquired by the date and time acquisition means is the later, of the user reserving the first reservation frame and the user reserving the second reservation frame.

According to the present invention, of the user reserving the first reservation frame and the user reserving the second reservation frame, the user who made a reservation at a later date and time is given a proposal to change the reservation. This can achieve a higher probability of changing the reservation. It is therefore possible to achieve a higher probability that the number of users reserving the reservation frame reserved by the change of the reservation becomes equal to or larger than the minimum number of users.

The invention according to claim 4 is the information processing apparatus according to claim 2 or 3, wherein: the identification information acquisition means acquires the identification information of the user reserving one in which a difference between the number of users having made the reservation and the minimum number of users is the larger, of the first reservation frame and the second reservation frame.

According to the present invention, of the first reservation frame and the second reservation frame, the user reserving the reservation frame in which the difference between the number of users having made the reservation and the minimum number of users is the larger is given a proposal to change the reservation to a reservation of the reservation frame in which the difference between the number of users having made the reservation and the minimum number of users is the smaller. It is therefore possible to achieve a higher probability that the number of users reserving the reservation frame reserved by change of the reservation becomes equal to or larger than the minimum number of users.

The invention according to claim 5 is the information processing apparatus according to any one of claims 2 to 4, further comprising: an address acquisition means that acquires, from an address storage means that stores an address information indicating an address of a user, an address information of a user reserving the first reservation frame and an address information of a user reserving the second reservation frame; and a comparison means that compares, based on addresses information acquired by the address acquisition means, accessibility with which the user reserving the first reservation frame reaches a place at which the event is to be held and accessibility with which the user reserving the second reservation frame reaches a place at which the event is to be held, and wherein: the identification information acquisition means acquires, based on a result of comparison in accessibility by the comparison means, the identification information of the user having the easier accessibility, of the user reserving the first reservation frame and the user reserving the second reservation frame.

According to the present invention, of the user reserving the first reservation frame and the user reserving the second reservation frame, the user who can reach with the easier accessibility a place at which the event is to be held is given a proposal to change the reservation. This can achieve a higher probability of changing the reservation. It is therefore possible to achieve a higher probability that the number of users reserving the reservation frame reserved by the change the reservation becomes equal to or larger than the minimum number of users.

The invention according to claim 6 is the information processing apparatus according to any one of claims 2 to 5, further comprising: a history acquisition means that acquires, from a history storage means that stores a history of operation by a user on a website in which a reservation frame available can be searched for, a history of a user reserving the first reservation frame and a history of a user reserving the second reservation frame; and a probability comparison means that compares, based on histories acquired by the history acquisition means, a probability with which the user reserving the first reservation frame may change reservation and a probability with which the user reserving the second reservation frame may change reservation, and wherein: the identification information acquisition means acquires, based on a result of comparison in probability by the probability comparison means, the identification information of the user having the higher probability, of the user reserving the first reservation frame and the user reserving the second reservation frame.

According to the present invention, of the user reserving the first reservation frame and the user reserving the second reservation frame, the user having the higher probability of changing the reservation is given a proposal to change the reservation, based on the operation history. This can achieve a higher probability of changing the reservation. It is therefore possible to achieve a higher probability that the number of users reserving the reservation frame reserved by the change of the reservation becomes equal to or larger than the minimum number of users.

The invention according to claim 7 is the information processing apparatus according to claim 1, wherein: the search means searches for the second reservation frame in which the number of users acquired by the number-of-users-acquisition means is equal to or larger than the minimum number of users; and the identification information acquisition means acquires identification information of a user reserving the first reservation frame.

According to the present invention, the user reserving the first reservation frame is given a proposal to change the reservation to a reservation of the second reservation frame. The user originally having reserved the second reservation frame can participate in the event, even when the user who has been given the proposal to change the reservation did not change the reservation. In addition, it is possible to achieve a higher probability that the user who has been given the proposal to change the reservation and changes the reservation can participate in the event.

The invention according to claim 8 is an information processing apparatus comprising: a number-of-users-acquisition means that acquires, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search means that when reservation frames which are reserved include a first reservation frame in which the number of users which is acquired by the number-of-users-acquisition means is smaller than the minimum number of users, searches for a second reservation frame in which the number of users acquired by the number-of-users-acquisition means is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved; an identification information acquisition means that when the second reservation frame is found by the search means, acquires, from a storage means that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and an identification information acquisition means that when the second reservation frame is found by the search means, acquires, from a storage means that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and an output means that outputs, based on the identification information acquired by the identification information acquisition means, information of giving the users identified by the identification information a proposal to change the reservation to a reservation of the first reservation frame.

According to the present invention, the number of users reserving the second reservation frame is larger than the minimum number of users, and the second reservation frame is searched for so that the difference between the number of users reserving the second reservation frame and the minimum number of users of the second reservation frame is equal to or larger than the difference between the number of users reserving the first reservation frame and the minimum number of users of the first reservation frame. Of the users reserving the second reservation frame, the users the number of whom is within the range that is equal to or larger than the difference between the number of users reserving the first reservation frame and the minimum number of the first reservation frame are given a proposal to change the reservation to a reservation of the first reservation frame. When a certain number of users of the users who were given the proposal to change the reservation change the reservations to reservations of the first reservation and the certain number corresponds to the difference between the number of users reserving the first reservation frame and the minimum number of users of the first reservation frame, the number of users reserving the first reservation frame is equal to or larger than the minimum number of users of the first reservation frame. This enables the user originally having reserved the first reservation frame to participate in the event. It is therefore possible to reduce the risk that a reservation is automatically cancelled by failure in collecting finally users the number of whom is equal to or larger than the minimum number of users.

The invention according to claim 9 is an information processing method to be executed by a computer, the method comprising: a number-of-users-acquisition step of acquiring, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search step of, when reservation frames which are reserved include a first reservation frame in which the number of users acquired in the number-of-users-acquisition step is smaller than the minimum number of users, searching for a second reservation frame in which the number of users acquired in the number-of-users-acquisition step is smaller than the maximum number of users and a total amount of the number of users reserving the second reservation frame and a number of at least part of the users reserving the first reservation frame is equal to or larger than the minimum number of users, from among the reservation frames which are reserved; an identification information acquisition step of, when the second reservation frame is found in the search step, acquiring, from a storage means that stores identification information for identifying a user in association with a reservation frame reserved by the user, identification information of a user reserving a reservation frame which is any one of the first reservation frame and the second reservation frame, the number of users of the any one acquired in the number-of-users-acquisition step being smaller than the minimum number of users of the any one; and an output step of outputting, based on the identification information acquired in the identification information acquisition step, information of giving the user identified by the identification information a proposal to change the reservation to a reservation of the other, which has not been reserved by the user, of the first reservation frame and the second reservation frame.

The invention according to claim 10 is an information processing method to be executed by a computer comprising: a number-of-users-acquisition step of acquiring, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search step of, when reservation frames which are reserved include a first reservation frame in which the number of users which is acquired in the number-of-users-acquisition step is smaller than the minimum number of users, searching for a second reservation frame in which the number of users acquired in the number-of-users-acquisition step is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved; an identification information acquisition step of, when the second reservation frame is found by the search means, acquiring, from a storage means that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and an identification information acquisition step of, when the second reservation frame is found in the search step, acquiring, from a storage means that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and an output step of outputting, based on the identification information acquired in the identification information acquisition step, information of giving the users identified by the identification information a proposal to change the reservation to a reservation of the first reservation frame.

The invention according to claim 11 is an information processing program to be executed to cause a computer to function as: a number-of-users-acquisition means that acquires, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search means that when reservation frames which are reserved include a first reservation frame in which the number of users acquired by the number-of-users-acquisition means is smaller than the minimum number of users, searches for a second reservation frame in which the number of users acquired by the number-of-users-acquisition means is smaller than the maximum number of users and a total amount of the number of users reserving the second reservation frame and a number of at least part of the users reserving the first reservation frame is equal to or larger than the minimum number of users, from among the reservation frames which are reserved; an identification information acquisition means that when the second reservation frame is found by the search means, acquires, from a storage means that stores identification information for identifying a user in association with a reservation frame reserved by the user, identification information of a user reserving a reservation frame which is any one of the first reservation frame and the second reservation frame, the number of users of the any one acquired by the number-of-users-acquisition means being smaller than the minimum number of users of the any one; and an output means that outputs, based on the identification information acquired by the identification information acquisition means, information of giving the user identified by the identification information a proposal to change the reservation to a reservation of the other, which has not been reserved by the user, of the first reservation frame and the second reservation frame.

The invention according to claim 12 is an information processing program to be executed to cause a computer to function as: a number-of-users-acquisition means that acquires, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users; a search means that when reservation frames which are reserved include a first reservation frame in which the number of users which is acquired by the number-of-users-acquisition means is smaller than the minimum number of users, searches for a second reservation frame in which the number of users acquired by the number-of-users-acquisition means is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved; an identification information acquisition means that when the second reservation frame is found by the search means, acquires, from a storage means that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and an identification information acquisition means that when the second reservation frame is found by the search means, acquires, from a storage means that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and an output means that outputs, based on the identification information acquired by the identification information acquisition means, information of giving the users identified by the identification information a proposal to change the reservation to a reservation of the first reservation frame.

### Advantageous Effect of Invention

According to the present invention, a user reserving any one of the first reservation frame and the second reservation frame is given a proposal to change the reservation. The change of the reservation to a reservation of the other one, which the user who have been given the proposal to change the reservation has not been reserved, enables reduction of the risk that a reservation is automatically cancelled by failure in collecting finally users the number of whom is equal to or larger than the minimum number of users

### BRIEF DESCRIPTION OF DRAWINGS

FIG. 1 is a view showing an example of a schematic configuration of an information processing system S according to one embodiment of the present invention.

FIG. 2 is an example of display of a time frame selection page in a case where a single person reservation frame is selected as a kind of frame.

FIG. 3A is a view showing an example of a situation of reservation in a case where the event holding conditions-satisfying reservation frame is used as a receiving reservation frame, FIG. 3B is an example of a body of a reservation change proposal mail; and FIG. 3C is an example of a situation of reservation after change of the reservation.

FIG. 4A is a block diagram showing an example of a schematic configuration of a golf course reservation server 1 according to one embodiment of the present invention, and FIG. 4B is an example of a function block of the golf course reservation server 1 according to the embodiment of the present invention.

FIG. 5A is a view showing an example of contents to be registered in a member information DB 12a, FIG. 5B is a view showing an example of contents to be registered in a golf course information DB 12b, FIG. 5C is a view showing an example of contents to be registered in an reservation situation DB 12c, FIG. 5D is a view showing an example of contents to be registered in a reservation information DB 12d, and FIG. 5E is a view showing an example of contents to be registered in an operation history DB 12e.

FIG. 6 is a flowchart showing an example of a reservation change proposal processing in one front/back nine, by a system control unit 14 of the golf course reservation server 1 according to the embodiment of the present invention.

FIG. 7A is an example of a situation of reservation in a case where the event holding conditions-satisfying reservation frame in which the number of reservation users is smaller than the maximum number of participants by which the event can be held is used as a releasing reservation frame, FIG. 7B is an example of a situation of reservation after change of the reservation, FIG. 7C is an example of a situation of reservation in a case where the event holding conditions-satisfying reservation frame in which the number of reservation users reaches the maximum number of participants by which the event can be held is used as a releasing reservation frame, and FIG. 7D is an example of a situation of reservation after change of the reservation.

FIG. 8A is an example of a situation of reservation in a case where a user-shortage-reservation frame is used as a releasing reservation frame, and FIG. 8B is an example of a situation of reservation after change of the reservation.

FIG. 9 is a flowchart showing an example of a reservation change proposal processing in one front/back nine, by a system control unit 14 of the golf course reservation server 1 according to one embodiment of the present invention.

FIG. 10A is a flowchart showing a processing example of a proposal-subjected user determination processing in a case where the proposal-subjected user is determined based on reservation date and time, FIG. 10B is a flowchart showing a processing example of a proposal-subjected user determination processing in a case where the proposal-subjected user is determined based on the number of reservation users, FIG. 10C is a flowchart showing a processing example of a proposal-subjected user determination processing in a case where the proposal-subjected user is determined based on accessibility with which the user can reach a golf course, and FIG. 10D is a flowchart showing a processing example of a proposal-subjected user determination processing in a case where the proposal-subjected user is determined based on an operation history.

### EMBODIMENTS FOR CARRYING OUT THE INVENTION

Now, the embodiments of the present invention will be described below with reference to the drawings. The embodiments of the present invention as described below are embodiments in which the present invention is applied to the information processing system.

### 1. First Embodiment of the Present Invention

### [1-1. Summary of Configuration and Functions of Information Processing System]

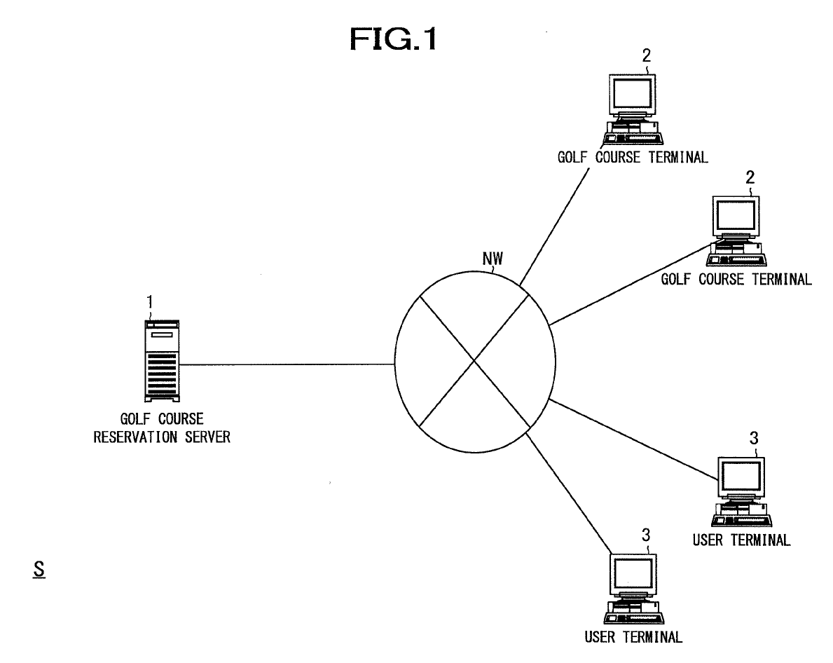

Now, the configuration of the information processing system according to the embodiment of the present invention will be described with reference to FIG. 1. FIG. 1 is a view showing an example of a schematic configuration of the information processing system S according to the embodiment of the present invention.

As shown in FIG. 1, the information processing system S includes a golf course reservation server 1, a plurality of golf course terminals 2 and a plurality of user terminals 3. It is possible to send or receive mutually data among the golf course reservation server 1, each golf course terminal 2 and each user terminal 3 through a network NW, e.g., with the use of a TCP/IP as a communication protocol. The network NW is constructed by for example an Internet, a dedicated communication line (e.g., a CATV (Community Antenna Television) line), a mobile communication network (including a base station, etc.), a gateway, and the like.

The golf course reservation server 1 is a server device that performs various kinds of processing for a reservation site in which golf courses are reserved. The golf course reservation server 1 is indicated as an example of the information processing apparatus of the present invention. A user may use the reservation site to reserve use of a golf course they desire. The golf course reservation server 1 may, for example, send a web page on a reservation site, or execute a processing regarding search, reservation, etc. of a golf course in response to a request from the user terminal 3. Golf is indicated as an example of the event in the present invention. The golf course is indicated as an example of a place in which the event is held in the present invention. The reservation site is indicated as an example of a website in the present invention.

The golf course terminal 2 is a terminal device which may be used by a golf course provider who provides a golf course. The golf course terminal 2 has access to server devices such as the golf reservation server 1 based on an operation by the golf course provider. This may cause the golf course terminal 2 to receive information on the web page from the server device. The golf course terminal 2 includes installed software for a browser, an electronic mail client, etc. The golf course provider may use the golf course terminal 2 to check a situation of reservation at the golf course as provided by the golf course provider and change the reservation.

The user terminal 3 is a terminal device of a user who uses a reservation site. The user terminal 3 may have access to the golf course reservation server 1 based on an operation by the user and receive the web page from the golf course reservation server 1 to display it. The user terminal 3 includes installed software for a browser, an electronic mail client, etc. As the user terminal 3, there may be used for example a personal computer, a handheld information terminal such a PDA (Personal Digital Assistant) and a smartphone, a cellular phone, etc.

### [1-2. Reservation Frame for Single Person

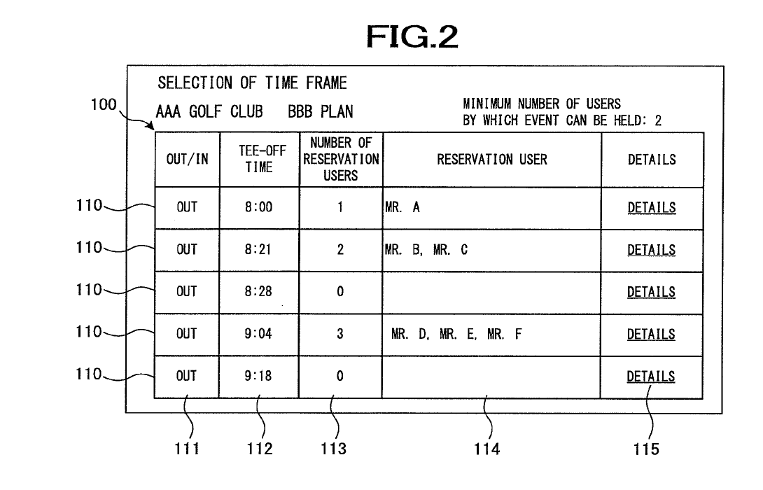

Now, a single person reservation frame will be described with reference to FIG. 2. In order to reserve a golf course in a reservation site, a user specify a time when a golf play is to be started. This time may be referred to as the “tee-off time”. A plurality of tee-off times is set for a front nine and a back nine of each golf course. In addition, an interval between the adjacent tee-off times is set for a golf course of each golf course. A period of time from a certain tee-off time to the next tee-off time may be referred to as the “time frame”. The time frame is indicated as an example of the reservation frame in the present invention. The time frames of this embodiment of the present invention are associated with golf courses of golf courses. Through the time frame corresponding to the tee-off time specified by a user, the user may reserve a golf course and a front nine or a back nine which correspond to this time frame. Then, it is made a plan that a game of golf is to be started within the reserved time frame.

There are kind of time frames including a normal time frame and a single person reservation time frame. The golf course reservation server 1 may be configured so that, for example, the golf course provider can set the time frame, in which the golf course is to be provided, as any one of the normal time frame and the single person reservation time frame in each time frame.

The normal time frame is defined as a time frame which can be reserved to permit a group consisting of at least two persons to play golf. For example, a representative of the group may reserve the normal time frame on the reservation website.

The single person reservation time frame is a time frame which can be reserved by a single user. A plurality of users may reserve one single person reservation time frame. A plurality of users who have reserved a certain single person reservation time frame will play golf together. The number of users who have reserved a certain single person reservation frame may be referred to as the “number of reservation users”. The minimum number of participants by which the event can be held and the maximum number of participants by which the event can be held have previously been set for the single person reservation frame. The minimum number of participants by which the event can be held is indicated as an example of the minimum number of event participating users in the present invention. The maximum number of participants by which the event can be held is indicated as an example of the maximum number of event participating users in the present invention. The minimum number of participants by which the event can be held is defined as a requirement to hold an event of golf at the single person reservation frame. More specifically, the minimum number of participants by which the event can be held is the minimum number of players which is required to hold the event of golf. That is, the single person reservation frame is the minimum value of the number of reservation users for holding the event of golf. The minimum number of participants by which the event can be held may be set for example to 2 or more. The single person reservation frame in which the number of current reservation users is equal to or larger than the minimum number of participants by which the event can be held may be referred to as the “event holding conditions-satisfying reservation frame”. The single person reservation frame in which the number of current reservation users is equal to or larger than one and smaller than the minimum number of participants by which the event can be held may be referred to as the “user-shortage-reservation frame”. The user-shortage-reservation frame is indicated as an example of the first reservation frame in the present invention.

The golf course reservation server 1 may determine for example if the number of reservation users is equal to or larger than the minimum number of participants by which the event can be held, at a predetermined time on a day before the date of play in the reserved single person reservation frame. This time may be referred to as the “holding-event-determination time”. The holding-event-determination time may be for example twelve noon, etc. When the golf course reservation server 1 judges that the number of reservation users is equal to or larger than the minimum number of participants by which the event can be held, the server determines the event of golf to be held. In this case, the golf course reservation server 1 sends an electronic mail to each user reserving the single person reservation frame to inform them that the event of golf is to be held, for example. On the other hand, when the golf course reservation server 1 judges that the number of reservation users is smaller than the minimum number of participants by which the event can be held, the server determines the event of golf not to be held. In this case, the golf course reservation server 1 performs a processing of cancelling the reservation of the single person reservation frame. Then, the golf course reservation server 1 sends an electronic mail to each user reserving the single person reservation frame to inform them that the number of reservation users is smaller than the minimum number of participants by which the event can be held, and the reservation has automatically be cancelled, for example.

The maximum number of participants by which the event can be held is the number of users can play golf through the single person reservation frame. Accordingly, users the number of whom is equal to or smaller than the maximum number of participants by which the event can be held may reserve a single person reservation frame. The maximum number of participants by which the event can be held may be set for example to 2 or more. The maximum number of participants by which the event can be held may be for example four. At least one of the minimum number and the maximum number of participants by which the event can be held may freely be set by a golf course provider, for example. The same minimum numbers of participants by which the event can be held and the same maximum numbers of participants by which the event can be held may be set in all the time frames in one golf course. Or, the minimum number and the maximum number of participants by which the event can be held may be set in each of the time frames. In this case, there may be a difference in at least one of the minimum number of participants by which the event can be held and the maximum number of participants by which the event can be held, between some time frames. Alternatively, the same minimum number of participants by which the event can be held and the same maximum number of participants by which the event can be held may previously be set throughout the whole reservation site.

The user may input various search conditions when searching for a golf course on the reservation site. The golf course reservation server 1 searches for golf courses for which available reservation plans are provided, under the specified search conditions. The plan is a service including the providing of a golf course. The plan is to be made for example by a golf course provider. The search conditions may include for example a date of play, a range of charges, a region, a desired tee-off time period, a name of golf course, a kind of frame, etc. The date of play is a date on which a game of golf is to be played in a golf course. The desired tee-off time period is a period of time in which a user wishes to start a game of golf. The desired tee-off time period may be specified for example in a manner of designating a period between nine and ten o'clock, a period between ten to eleven o'clock, etc. The kind of frame indicates whether the time frame to be searched for is the normal time frame or the single person reservation frame.

When a golf course has been found, a golf course search result page is displayed on a screen of the user terminal 3. On the golf course search result page, there is displayed a list of found golf course, as the search results of the golf course. When the user has selected a desired golf course in the list, the golf course page is displayed on the screen of the user terminal 3. The golf course page includes information, as displayed, about the selected golf course. In addition, on the golf course page, there is displayed a list of plans which satisfies the search conditions in the selected golf course. When the user has selected a combination of a plan and a date of play on the golf course page, the golf course reservation server 1 searches for available time frames in the selected combination. This permits to make a search for the available time frames on the reservation site. When the desired tee-off time period has been specified as the search condition, the golf course reservation server 1 searches for available time frames in the desired tee-off time period which is specified, for example. In a case where the kind of frame is the single person reservation frame, the available time frames is the single person reservation frame in which the number of reservation users is smaller than the maximum number of participants by which the event can be held.

When the time frame has been found, the time frame selection page is displayed on the screen of the user terminal 3. On the time frame selection page, there is displayed a list of found time frames, as the search results of the time frames. FIG. 2 is an example of display of the time frame selection page in a case where the single person reservation frame is selected as the kind of frame. As shown in FIG. 2, the time frame selection page includes a search result region 100. The search result region 100 includes time frame information 110, as displayed, for each found single person reservation frame. The time frame information 110 includes a front/back nine indicator 111, a tee-off time 112, the number of current reservation users 113, a list of reservation users 114 and a particulars-link 115, as displayed. The list of reservation users 114 is a list of users reserving the single person reservation frame indicated by the tee-off time 112. The list of reservation users 114 includes for example a nickname of the user as displayed. The list of reservation users 114 may include for example an image, as displayed, of a face indicative of the user. The particulars-link 1115 is a hyper-link to the time frame detail page. The time frame detailed page is a webpage on which the detailed information on the single person reservation frame is displayed. On the time frame detail page, there are displayed for example a name of golf course, a date of play, a tee-off time, a charge, a name of plan, the minimum number of participants by which the event can be held, a content of plan, remarks, etc. In addition, the time frame detail page includes a reservation button as displayed. The reservation button is a button by which there may be reserved the single person reservation frame of which information is presented on the time frame detail page. When one or more users reserving the single person reservation frame exist, the time frame detail page further includes a profile, as displayed, of the user making the reservation. There are displayed, as the profile, for example the user' s nickname, age, gender, level of golf, playing style, self-introduction, spirit, etc. The level of golf is indicative of a skill of golf. The level is indicated for example in the form of an average of scores of the games of golf previously played. The playing style, the self-introduction, the spirit, etc. are inputted by the user, for example, when the user reserves the single person reservation frame.

### [1-3. Adjustment of the Number of Reservation Users by Giving a Proposal to Change Reservation]

When time has come to the holding-event-determination time in a state where the number of reservation users is smaller than the minimum number of participants by which the event can be held, the reservation is automatically cancelled. As a result, the user loses the chance to play golf, despite making the reservation. If there exists a user-shortage-reservation frame, the golf course reservation server 1 gives the user reserving any single person reservation frame a proposal to change the reservation to a reservation of another single person reservation frame. The original time frame from which the reservation is to be changed may be referred to as the “releasing reservation frame”. The time frame to which the reservation is to be changed may be referred to as the “receiving reservation frame”. The golf course reservation server 1 determines at least one of the releasing reservation frame and the receiving reservation frame to be the user-shortage-reservation frame. The change of the reservation by the user who has been proposed to change the reservation causes the number of reservation users of the receiving reservation frame to increase. If the number of reservation users in the receiving reservation frame is equal to or larger than the minimum number of participants by which the event can be held, it is possible for the user who has originally reserved the receiving reservation frame and the user who has changed the reservation to a reservation of the receiving reservation frame to play golf. Therefore, it is possible for the user who reserved a time frame which was the user-shortage-reservation frame in the beginning to play golf. The user who is to be proposed to change the reservation may be referred to as the “proposal-subjected user”. The golf course reservation user 1 determines at least one of users reserving the releasing reservation frame as the proposal-subjected user.

A time frame to which the reserved time frame is changed from the user-shortage-reservation frame or a time frame from which the reserved time frame is changed to the user-shortage-reservation frame is required. Therefore, when there exists the user-shortage-reservation frame, the golf course reservation server 1 judges if there exists a time frame in which the number of reservation users may be changed. The time frame in which the number of reservation users may be changed may be referred to as the “changeable-number-of-users-frame”. The changeable-number-of-users-frame is an example of the second reservation frame in the present invention. In the embodiment of the present invention, the changeable-number-of-users-frame is a time frame is a time frame which allows at least one of a reduction and an increase in the number of reservation users while maintaining a state in which the number of reservation users is equal to or larger than the minimum number of participants by which the event can be held, when the number of reservation users of the time frame is equal to or larger than the minimum number of participants by which the event can be held. The reason for it is that, if the number of reservation users becomes smaller than the minimum number of participants by which the event can be held due to the reduction in the number of reservation users, the user who had originally permitted to play golf cannot play golf. The golf course reservation server 1 may use a time frame in which the number of reservation users is smaller than the minimum number of participants by which the event can be held, i.e., the user-shortage-reservation frame, as the changeable-number-of-users-frame. The user who had originally reserved the user-shortage-reservation frame may not play golf by the current number of reservation users. Accordingly, neither decrease nor increase in the number of reservation users in the user-shortage-reservation frame causes any problem.

The golf course reservation server 1 searches for, as the changeable-number-of-users-frame, a time frame in which the current number of reservation users is different from at least one of the minimum number and the maximum number of participants by which the event can be held. More specifically, the changeable-number-of-users-frames does not include the time frame having a relationship of the number of reservation users=the minimum number of participants by which the event can be held=the maximum number of participants by which the event can be held. The reason for it is as follows: When the relationship of the number of reservation users=the minimum number of participants by which the event can be held=the maximum number of participants by which the event can be held, the number of reservation users has reached the maximum number of participants by which the event can be held and thereby any reservation from a user reserving the user-shortage-reservation frame cannot be accepted. In addition, since the number of reservation users is equal to the number of the minimum number of participants by which the event can be held, the event holding conditions are not satisfied if any one of the reservation users has changed the reservation to the user-shortage-reservation frame. Accordingly, the number of reservation users can neither be increased nor decreased. On the other hand, the time frame having a relationship of the number of reservation users<the minimum number of participants by which the event can be held is the user-shortage-reservation frame. Accordingly, the number of reservation users can either be increased or decreased. When a relationship of the reservation users>the minimum number of participants by which the event can be held, the number of reservation users can at least be decreased to the minimum number of participants by which the event can be held. When a relationship of the reservation users<the maximum number of participants by which the event can be held, the number of reservation users can at least be increased to the maximum number of participants by which the event can be held. Incidentally, the golf course reservation server 1 may search for the changeable-number-of-users-frame from among time frames corresponding to a golf course, a date of play and a front nine or back nine which are the same as those corresponding to the user-shortage-reservation frame. Incidentally, the golf course reservation server 1 may search for changeable-number-of-users-frames in the same golf course, date of play and course as those having the user-shortage-reservation frame.

More specifically, the golf course reservation server 1 searches for, as the changeable-number-of-users-frame, a time frame in which the number of reservation users is smaller than the maximum number of participants by which the event can be held, and a total amount of the number of reservation users reserving this time frame and at least part of the number of users reserving the user-shortage-reservation frame is equal to or larger than the minimum number of participants by which the event can be held, of any one of the above-mentioned time frame and the user-shortage-reservation frame. The time frames satisfying such conditions include the event holding conditions-satisfying reservation frame in which the number of reservation users is smaller than the maximum number of participants by which the event can be held, and a user-shortage-reservation frame.

When both of the user-shortage-reservation frame and the changeable-number-of-users-frame have been judged to exist, the golf course reservation server 1 determines a proposal-subjected user. More specifically, the golf course reservation server 1 determines, as the proposal-subjected user, a user who has reserved the time frame which is any one, of the user-shortage-reservation frame and the changeable-number-of-users-frame, in which the number of reservation users is smaller than the minimum number of participants by which the event can be held. When the changeable-number-of-users-frame is the event holding conditions-satisfying reservation frame, the golf course reservation server 1 determines the user reserving the user-shortage-reservation frame as the proposal-subjected user. When the changeable-number-of-users-frame is the user-shortage-reservation frame, the golf course reservation server 1 determines the user reserving any user-shortage-reservation frame as the proposal-subjected user. Then, the golf course reservation server 1 outputs information proposing the proposal-subjected user to change the reservation from the reservation of releasing reservation frame to a reservation of the receiving reservation frame. The golf course reservation server 1 may send for example an electronic mail as the information proposing to change the reservation. This electronic mail may be referred to as the “the reservation change proposal mail”.

The processing of judging if the user-shortage-reservation frame and the changeable-number-of-users-frame exist and of sending the reservation change proposal mail may be referred to as the “reservation change proposal processing”. The golf course reservation server 1 may perform the reservation change proposal processing for example once a day. The golf course reservation server 1 may perform the reservation change proposal processing at any time before reservation of the single person reservation frame which is subjected to the processing is closed. The golf course reservation server 1 may perform the reservation change proposal processing on the day before the date of play corresponding to the single person reservation frame which is subjected to the processing. In this case, the reservation change proposal processing may be performed at the holding-event-determination time, a predetermined time before the holding-event-determination time, or predetermined time after the holding-event-determination time. Alternatively, the golf course reservation server 1 may perform the reservation change proposal processing for example on the very day of the date of play.

In the embodiment of the present invention, the golf course reservation server 1 judges if any event holding conditions-satisfying reservation frame exists, as the changeable-number-of-users-frame. The golf course reservation server 1 may search for, for example, the event holding conditions-satisfying reservation frame in which the current number of reservation users is smaller than the maximum number of participants by which the event can be held. More specifically, the golf course reservation server 1 searches for the time frame having a relationship of the minimum number of participants by which the event can be held≦the number of reservation users<the maximum number of participants by which the event can be held. Irrespective of the number of reservation users of the user-shortage-reservation frame, a total amount of the number of reservation users of the event holding conditions-satisfying reservation frame and the number of reservation users of the user-shortage-reservation frame becomes equal to or larger than the minimum number of participants, by which the event can be held, of the event holding conditions-satisfying reservation frame. The number of reservation users may be increased in the event holding conditions-satisfying reservation frame in which the number of reservation users is smaller than the maximum number of participants by which the event can be held. Therefore, the golf course reservation server 1 determines the found event holding conditions-satisfying reservation frame as the receiving reservation frame and determines the user-shortage-reservation frame as the releasing reservation frame. In this case, the golf course reservation server 1 determines the user-shortage-reservation frame which becomes the releasing reservation frame and the event holding conditions-satisfying reservation frame which becomes the receiving reservation frame so that, for example, a total amount of the number of reservation users of the user-shortage-reservation frame and the number of reservation users of the event holding conditions-satisfying reservation frame becomes equal to or smaller than the maximum number of participants, by which the event can be held, of the event holding conditions-satisfying reservation frame.

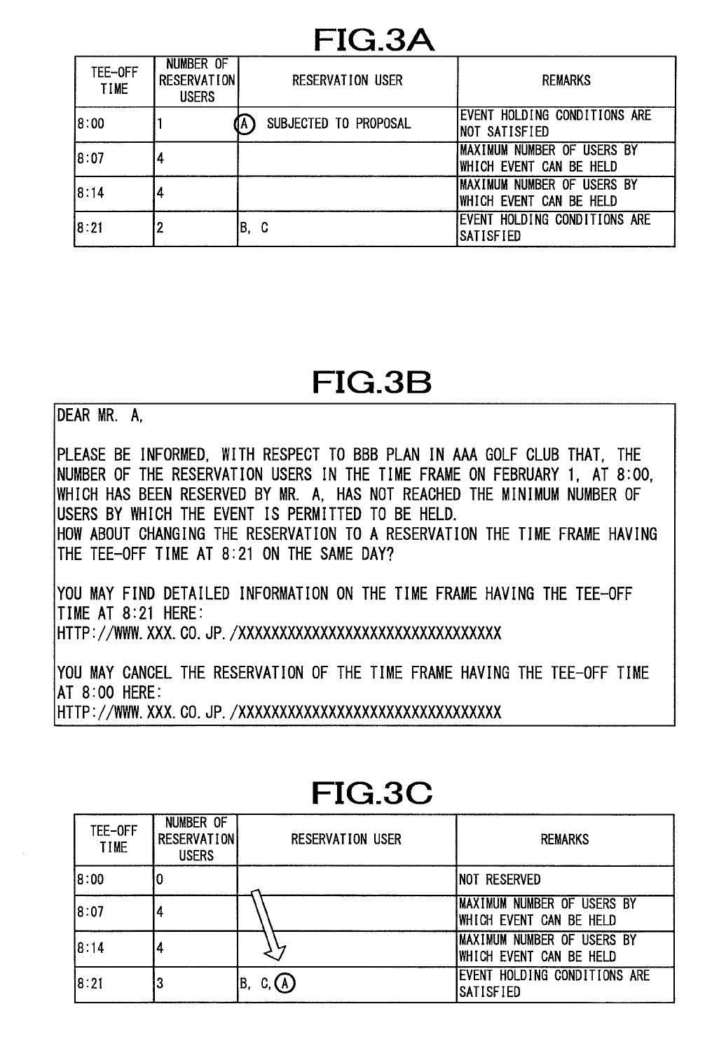

FIG. 3 shows a specific example in which the event holding conditions-satisfying reservation frame is used as the receiving reservation frame. In an example of FIG. 3, the minimum number of participants by which the event can be held is two and the maximum number of participants by which the event can be held is four in all the time frames. FIG. 3A is a view showing an example of a situation of reservation. As shown in FIG. 3A, the number of reservation users in the time frame at 8:00 is one. The reservation user is the user A. The number of reservation users in each of the time frame at 8:07 and 8:14 is four. The number of reservation users in the time frame at 8:21 is two. The reservation users are the users B and C. The time frame at 8:00 is the user-shortage-reservation frame. On the other hand, the number of reservation users in each of the time frames at 8:07 and at 8:14 reaches the maximum number of participants by which the event can be held, and, in this embodiment of the present invention, these frames are excluded from the changeable-number-of-users-frame. On the other hand, the time frame at 8:21 is the event holding conditions-satisfying reservation frame, and the number of reservation users does not reach the maximum number of participants by which the event can be held. Consequently, the time frame at 8:21 is the changeable-number-of-users-frame. In this case, the golf course reservation server 1 determines, for example, the time frame at 8:00 as the releasing reservation frame and determines the time frame at 8:21 as the receiving reservation frame. As a result, the golf course reservation server 1 determines the user A as the proposal-subjected user. Therefore, the golf course reservation server 1 sends a reservation change proposal mail to the user A.

FIG. 3B is an example of a body of the reservation change proposal mail. As shown in FIG. 3B, the reservation change proposal mail may include, for example, a message informing that the number of reservation users in the time frame reserved by the proposal-subjected user has not reached the minimum number of participants by which the event can be held, a message recommending to change the reservation to a reservation of the receiving reservation frame, a tee-off time of the receiving reservation frame, an URL of the time frame detail page of the receiving reservation frame, an URL of a webpage on which the proposal-subjected user can cancel the reservation of the time frame reserved by them, and the like. Alternatively, the reservation change proposal mail may include for example, only a message recommending changing the reservation to a reservation of the receiving reservation frame, and a tee-off time of the receiving reservation frame.

FIG. 3C is an example of a situation of reservation after change of the reservation. It is assumed that the user A who viewed the reservation change proposal mail cancels the reservation of the time frame at 8:00 and reserves the time frame at 8:21. In this case, the number of reservation users of the time frame at 8:21 becomes three, as shown in FIG. 3C. The time frame at 8:21 still satisfies the event conditions even after the change of reservation. Accordingly, the user A can play golf. When the event holding conditions-satisfying reservation frame is used as the receiving reservation frame, the user who have originally reserved the receiving reservation frame can play golf, irrespective of the change of the reservation from the user-shortage-reservation frame. This ensures the user who has changed the reservation from the reservation of the user-shortage-reservation frame to the reservation of the event holding conditions-satisfying reservation frame to play golf.

There may be a case where a total amount of the number of reservation users of the user-shortage-reservation frame and the number of reservation users of the event holding conditions-satisfying reservation frame exceeds the maximum number of participants by which the event can be held. There is assumed for example that the minimum number of participants by which the event can be held is three and the maximum number of participants by which the event can be held is four. In addition, there is assumed that the number of reservation users of the user-shortage-reservation frame is two and the number of reservation users of the event holding conditions-satisfying reservation frame is three. In this case, only one user of the users reserving the user-shortage-reservation frame can change the reservation to a reservation of the event holding conditions-satisfying reservation frame. In this case, the golf course reservation server 1 may determine for example all the users reserving the user-shortage-reservation frame as the proposal-subjected user. In this case, the user who completed early a reservation proceeding for the event holding conditions-satisfying reservation frame can make the change of reservation. Alternatively, the golf course reservation server 1 may determine, as the proposal-subjected user, only the users the number of whom corresponds the difference between the maximum number of participants, by which the event can be held, of the event holding conditions-satisfying reservation frame and the number of reservation users of the event holding conditions-satisfying reservation frame.

When only a part of the users reserving the releasing reservation frame is determined as the proposal-subjected user, the golf course reservation server 1 may determine freely the proposal-subjected user. Alternatively, the golf course reservation server 1 may determine the proposal-subjected user based on predetermined conditions. The golf course reservation server 1 may determine the user having a higher probability of changing the reservation as the proposal-subjected user. Ways of specifying the user having the higher probability of changing the reservation may include for example a way based on the reservation date and time, a way based on accessibility with which the user can reach a golf course, a way based on an operation history of the user on the reservation site, etc. For example, a user having a later reservation date is apt to have a higher probability of flexibly handling the change of the plan of golf. Accordingly, the golf course reservation server 1 may preferentially determine the user having a later reservation date as a proposal-subjected user. A user whose address is located near a golf course is apt to have a higher probability of flexibly handling the change of the plan of golf. Therefore, the golf course reservation server 1 may preferentially determine the user having an easier accessibility with which the user can reach a golf course as a proposal-subjected user. The golf course reservation server 1 records data of operation histories of a user on the reservation site. The operation histories include search histories of the golf course, browsing histories of the webpage. It is therefore possible to specify a desired tee-off time period specified as the search condition by the user, and a time frame of which information has been browsed by the user. There is a high probability that a user wishes to start the game of golf in the time frame within the desired tee-off time period which is specified. And there is a high probability that a user wishes to start the game of golf in the time frame of which information has been browsed. If there is proposed the change of reservation to a reservation of the time frame in which the user may wish to have a high probability of playing golf, there is a higher probability that the user may change the reservation. Therefore, the golf course reservation server 1 may preferentially determine the user having a higher probability of changing the reservation as a proposal-subjected user based on the operation history.

The golf course reservation server 1 may for example use, for a single event holding conditions-satisfying reservation frame, a plurality of user-shortage-reservation frames as the releasing reservation frame. There is assumed for example that the minimum number of participants by which the event can be held is three and the maximum number of participants by which the event can be held is five. In addition, it is assumed that there exist two user-shortage-reservation frame having the number of reservation users is one, and there exists one event holding conditions-satisfying reservation frame having the number of reservation users of three. In this case, the golf course reservation server 1 proposes the users reserving the respective user-shortage-reservation frames to change their reservations to reservations of the event holding conditions-satisfying reservation frame. It is assumed that each of the users reserving the user-shortage-reservation frames changes the reservation to a reservation of the event holding conditions-satisfying reservation frame. In this case, the number of reservation users of the event holding conditions-satisfying reservation frame becomes five.

The golf course reservation server 1 may for example use, for a single user-shortage-reservation frame, a plurality of event holding conditions-satisfying reservation frames as the receiving reservation frame. There is assumed for example that the minimum number of participants by which the event can be held is three and the maximum number of participants by which the event can be held is four. In addition, it is assumed that there exists one user-shortage-reservation frame having the number of reservation users of two, and there exist two event holding conditions-satisfying reservation frames having the number of reservation users of three. In this case, the golf course reservation server 1 proposes two users reserving the user-shortage-reservation frame to change their reservations to the different event holding conditions-satisfying reservation frames. It is assumed that the users reserving the user-shortage-reservation frame change their reservations to the different event holding conditions-satisfying reservation frames. In this case, the number of reservation users of each of the event holding conditions-satisfying reservation frames becomes four.

### [1-4. Configuration of Golf Course Reservation Server]

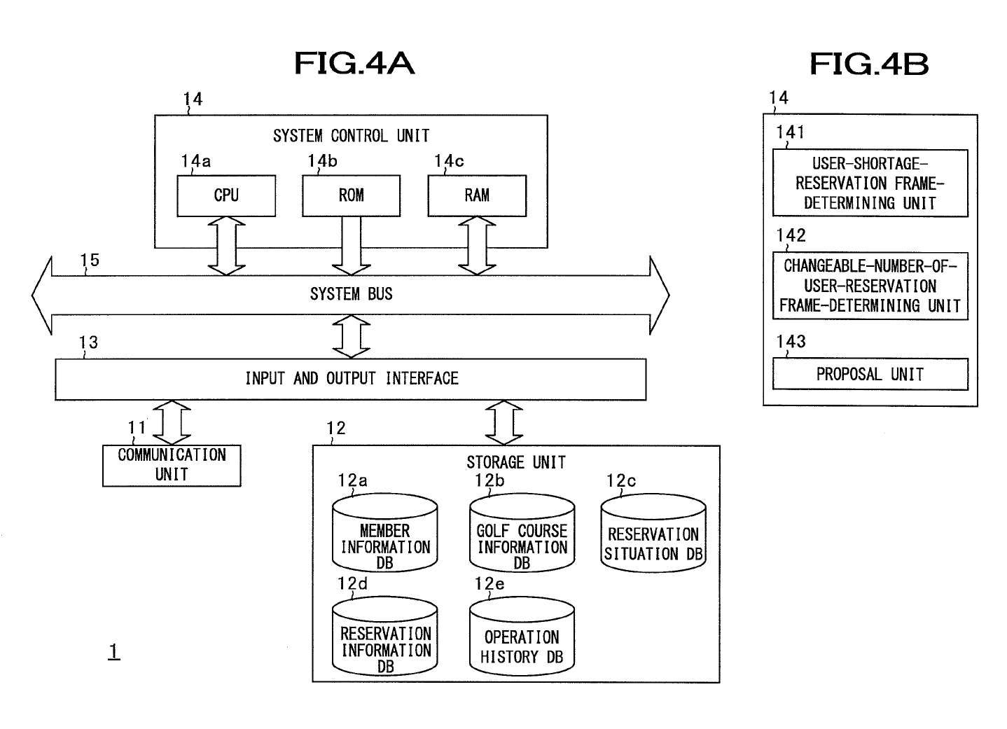

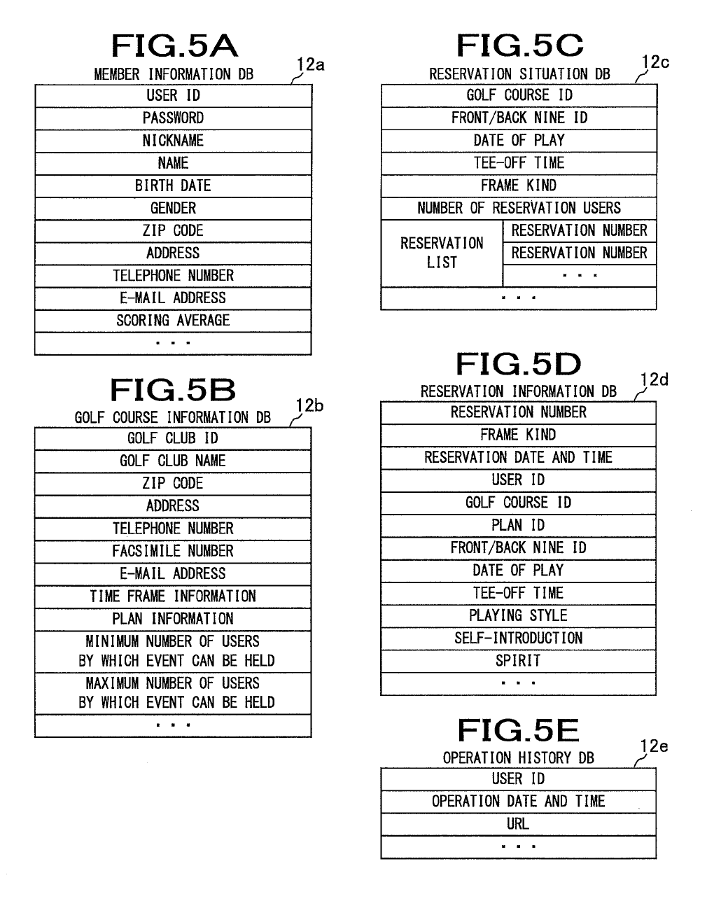

Now, the configuration of the golf course reservation server 1 will be described with reference to FIGS. 4 and 5.

FIG. 4A is a block diagram showing an example of a schematic configuration of the golf course reservation server 1 according to the embodiment of the present invention. As shown in FIG. 4A, the golf course reservation server 1 includes a communication unit 11, a storage unit 12, an input and output interface 13 and a system control unit 14. The system control unit 14 and the input and output interface 13 are connected to each other through a system bus 15.

The communication unit 11 is configured to be connected to the network NW to control communication conditions with the golf course terminals 2, the user terminals 3, etc.

The storage unit 12 includes for example a hard disc drive, etc. The storage unit 12 is an example of the storage means, the address storage means and the history storage means of the present invention. In this storage unit 12, databases are established which include a member information DB 12a, a golf course information DB 12b, a reservation situation DB 12c, a reservation information DB 12d, an operation history DB 12e, etc. “DB” is an abbreviation for database.

FIG. 5A is a view showing an example of contents to be registered in the member information DB 12a. In the member information DB 12a, member information of the users who have registered as a member of the information processing system S is registered. More specifically, In the member information DB 12a attributes of the users which include a user ID, a password, a nickname, a name, a birth date, a gender, Zip code, an address, a telephone number, an E-mail address, a scoring average, etc. are registered in association with each other. The user ID is identification information of the user.

FIG. 5B is a view showing an example of contents to be registered in the golf course information DB 12b. In the golf course information DB 12b, golf course information on the golf course is registered. More specifically, In the golf course information DB 12b, attributes of the golf course which include a golf course ID, a golf course name, Zip code, an address, a telephone number, a facsimile number, an E-mail address, the minimum number of participants by which the event can be held, the maximum number of participants by which the event can be held, a time frame information, a plan information, etc. are registered in association with each other. The golf course ID is identification information of the golf course. The time frame information is information on time frames which have been set by a golf course provider. For example, in the time frame information, tee-off times of the respective time frames set for a day. The plan information is information on a plan provided by a golf course provider. The minimum number of participants by which the event can be held and the maximum number of participants by which the event can be held which have been registered in the golf course information DB 12b are the minimum number of participants by which the event can be held and the maximum number of participants by which the event can be held which have been set for all the time frames in the golf course identified by the golf course ID.

FIG. 5C is a view showing an example of contents to be registered in the reservation situation DB 12c. In the reservation situation DB 12c, a reservation situation of each golf course is registered. More specifically, in the reservation situation DB 12c, a golf course ID, a front/back nine id, a date of play, a tee-off frame kind, etc. are registered in association with the respective time frame for each time frame. The front/back nine id is identification information of each of a front nine and a back nine. The tee-off time is indicative of the time frame. The frame kind is indicative of a kind of the time frame. Any one of the “normal time frame” and the “single person reservation frame” is to be selected as the frame kind. When the “normal time frame” is selected as the frame kind, a reservation flag, etc. is further registered in the golf course information DB 12b. The reservation flag is indicative of if the time frame has been reserved. When the “single person reservation frame” is selected as the frame kind, the numbers of reservation users, a reservation list, etc. are further registered in the golf course information DB 12b. The number of reservation users is the number of users who have currently reserved the single person reservation frame. The reservation list is a list of users who have reserved the single person reservation frame. The reservation list includes the reservation numbers allotted to the reservation users. The reservation number is an identification number to be issued every time the reservation has been completed. The reservation number registered in the reservation user list is an identification number to be issued when a user has reserved the single person reservation frame. The golf course reservation server 1 may search the reservation information DB 12d with the reservation number to specify the user who has reserved the single person reservation frame. Incidentally, the number of reservation users is not necessarily registered in the reservation situation DB 12c. The reason for it is that the golf course reservation server 1 can acquire the number of reservation users by counting the number of the reservation numbers registered in the reservation list.

FIG. 5D is a view showing an example of contents to be registered in the reservation information DB 12d. In the reservation information DB 12d, reservation information is registered which is indicative of reservation contents of the golf course. The reservation information is information indicative of a history of reservation. More specifically, in the reservation information DB 12d, a reservation number, a frame kind, a reservation date and time, a user ID, a golf course ID, a plan ID, a front/back nine id, a date of play, a tee-off time, a playing style, a self-introduction, a spirit are registered in association with each other. The reservation number is information for identifying the reservation information. The frame kind indicates a kind of a reserved time frame. The reservation date and time is a date and time at which the reservation has been made. The user ID is indicative of a user who made the reservation. The golf course ID, the plan ID and the front/back nine id indicates a golf course, a plan and a front nine or a back nine which are reserved. The tee-off time is indicative of a reserved time frame. The playing style, the self-introduction and the spirit are information which has been inputted by the user who made the reservation.

FIG. 5E is a view showing an example of contents to be registered in the operation history DB 12e. In the operation history DB 12e operation history of the user in the reservation site is registered. In the operation history DB 12e, a user ID, an operation date and time, a URL, etc. are registered in association with each other. The golf course reservation server 1 registers the operation history every time the user operates the user terminal 3 to cause the user terminal 3 to send a request to the golf course reservation server 1. The user ID is indicative of a user who made the operation. The operation date and time is a date and time at which the operation was made. The URL is set in the request from the user terminal 3. The golf course reservation server 1 can specify contents of operation from the URL. The user's operations on the reservation site may include, for example, a search requesting operation of a golf course, a browsing operation of a webpage, a reservation operation, a logging-in operation to a reservation site, a logging-out operation, etc. The history of search requesting operation is a search history. The URL included in the search history includes search conditions inputted by a user. The history of the browsing operation of the webpage is a browsing history. The URL included in the browsing history of the time frame detail page include, as information for specifying the time frame, for example, a golf course ID, a plan ID, a front/back nine id, a date of play, a tee-off time, etc.

Now, the other information to be stored in the storage unit 12 will be described. In the storage unit 12, various kinds of data is stored which includes HTML documents, XML (Extensible Markup Language) documents, image data, text data, electronic documents, etc., for displaying web pages. In addition, in the storage unit 12, various kinds of set values, threshold values, constants, etc. are stored.

In addition, In the storage unit 12, various kinds of programs are stored which include an operating system, a WWW (World, Wide Web) server program, a DBMS (Database Management System), a reservation management program, etc. The reservation management program is a program to execute various kinds of processing about the reservation of a golf course. The reservation management program is an example of the information processing program of the present invention. The various kinds of programs may be acquired for example through the network NW from the other server device, etc., or may be recorded in a record medium such as a DVD (Digital Versatile Disc) so as to be read in through a drive device. In addition, the reservation management program may be a program product. The input and output interface 13 is configured to perform an interface processing between the communication unit 11 and the storage unit 12, on the one hand, and the system control unit 14, on the other hand.

FIG. 4B is an example of a function block of the golf course reservation server 1 according to the embodiment of the present invention. The system control unit 14 includes a CPU 14a, a ROM (Read Only Memory) 14b, a RAM (Random Access Memory) 14c, etc. The reading out and execution of the various kinds of programs by the UPU 14a causes the system control unit 14 to function as a user-shortage-reservation frame-determining unit 141, a changeable-number-of-user-reservation frame-determining unit 142 and a proposal unit 143, as shown in FIG. 4B. The user-shortage-reservation frame-determining unit 141 is an example of the acquisition means of the present invention. The changeable-number-of-user-reservation frame-determining unit 142 is an example of the search means of the present invention. The proposal unit 143 is an example of the identification information acquisition means and the output means of the present invention.

The user-shortage-reservation frame-determining unit 141 acquires the number of reservation users from the reservation situation DB 12c. Then, the user-shortage-reservation frame-determining unit 141 judges if there exists a user-shortage-reservation frame based on the acquired number of users. The changeable-number-of-user-reservation frame-determining unit 142 judges if there exists a changeable-number-of-users-frame based on the number of users acquired from the reservation situation DB 12c. The proposal unit 143 sends, if the user-shortage-reservation frame and the changeable-number-of-users-frame are judged to exist, the reservation change proposal mail to the proposal-subjected user.

Incidentally, the golf course reservation server 1 may include a plurality of server devices. For example, a server device that searches for the golf course and the time frame on the reservation site, a server device that performs a reservation processing, a server device that sends a webpage of the reservation site in response to a request from the user terminal 3, a server device that send an electronic mail, a server device that manages database, etc. may be connected to each other through a LAN, etc.

### [1-5. Operation of Information Processing System]

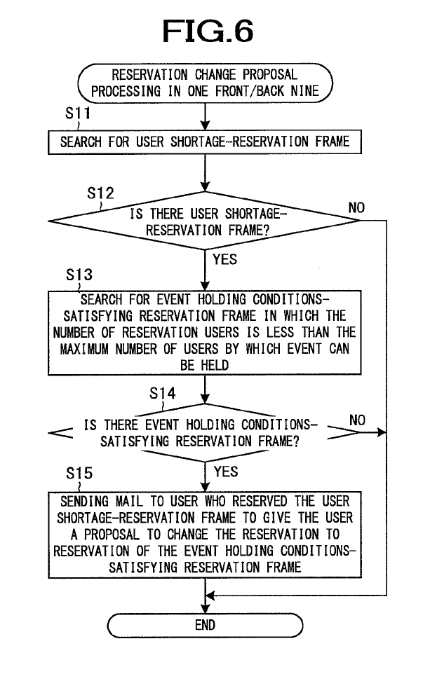

Now, an operation of the information processing system S will be described with the use of FIG. 6. FIG. 6 is a flowchart showing an example of the reservation change proposal processing by the system control unit 14 of the golf course reservation server 1 according to the embodiment of the present invention. The system control unit 14 performs the reservation change proposal processing for example once a day at a predetermined time. In the reservation change proposal processing, the system control unit 14 performs the reservation change proposal processing in one front/back nine, for example, for each front nine and back nine of each golf course. The reservation change proposal processing in one front/back nine is a processing of judging an existence of the user-shortage-reservation frame and the changeable-number-of-users-frame regarding the golf course and the front nine or back nine subjected to the processing, and of sending the reservation change proposal mail.

As shown in FIG. 6, the user-shortage-reservation frame-determining unit 141 searches for the user-shortage-reservation frames from among the single person reservation frames in which the game of golf is to be played, for example, tomorrow in golf course and the front nine or back nine subjected to the processing (Step S11). More specifically, the user-shortage-reservation frame-determining unit 141 searches the reservation situation DB 12c for the tee-off time in which the frame kind registered in association with the golf course and the front nine or back nine subjected to the processing and the date of play of tomorrow is the “single person reservation frame”. In addition, the user-shortage-reservation frame-determining unit 141 acquires, from the golf course information DB 12b, the minimum number of participants by which the event can be held and the maximum number of participants by which the event can be held of the golf course subjected to the processing. Then, the user-shortage-reservation frame-determining unit 141 searches, from among the found tee-off times, for the tee-off times of the reservation in which the number of reservation users registered in association with the tee-off time is one or more, and smaller than the minimum number of participants by which the event can be held. Then, the user-shortage-reservation frame-determining unit 141 judges if there exists a user-shortage-reservation frame based on the results of the search (Step S12). Here, when there exists no tee-off time of the reservation in which the frame kind is the single person reservation frame, or there exists no tee-off time of the reservation in which the number of reservation users is one or more, and smaller than the minimum number of participants by which the event can be held, the user-shortage-reservation frame-determining unit 141 judges that there exists no user-shortage-reservation frame (Step S12: NO). In this case, the user-shortage-reservation frame-determining unit 141 terminates the reservation change proposal processing in one front/back nine. On the other hand, when there exists the tee-off time of the reservation in which the number of reservation users is one or more, and smaller than the minimum number of participants by which the event can be held, the user-shortage-reservation frame-determining unit 141 judges that there exists the user-shortage-reservation frame (Step S12: YES). In this case, the user-shortage-reservation frame-determining unit 141 proceeds to Step S13.

If the reservation change proposal processing is performed after the holding-event-determination time, the user-shortage-reservation frame will automatically be cancelled. As a result, the user-shortage-reservation frame-determining unit 141 cannot search the reservation situation DB 12c for any user-shortage-reservation frame. In this case, the system control unit 14 may temporarily save the information on the user-shortage-reservation frame, for example when performing a cancel processing of the user-shortage-reservation frame. For example, the system control unit 14 may store the golf course ID, the front/back nine id, the date of play, the tee-off time, the number of reservation users, the reservation list, etc. in the storage unit 12. Then, the user-shortage-reservation frame-determining unit 141 may search for the user-shortage-reservation frames based on the stored information.

In Step S13, the changeable-number-of-user-reservation frame-determining unit 142 searches for an event holding conditions-satisfying reservation frames in which the number of reservation users is smaller than the maximum number of participants by which the event can be held, from among the single person reservation frame in which the date of play is tomorrow in the golf course and the front nine or back nine subjected to the processing. More specifically, the changeable-number-of-user-reservation frame-determining unit 142 searches for the tee-off time of data in which the number of reservation users registered in association with the tee-off time is equal to or larger than the minimum number of participants by which the event can be held and smaller than the maximum number of participants by which the event can be held, from among the tee-off times of data, found in Step S11, in which the frame kind is the “single person reservation frame”. Then, the changeable-number-of-user-reservation frame-determining unit 142 judges, based on the results of the search, if there exists an event holding conditions-satisfying reservation frame in which the number of reservation users is smaller than the maximum number of participants by which the event can be held (Step S14). In this case, the changeable-number-of-user-reservation frame-determining unit 142 terminates the reservation change proposal processing in one front/back nine, when no event holding conditions-satisfying reservation frame in which the number of reservation users is smaller than the maximum number of participants by which the event can be held is judged to exist (Step S14: NO). On the other hand, the changeable-number-of-user-reservation frame-determining unit 142 proceeds to Step S15, when the event holding conditions-satisfying reservation frame in which the number of reservation users is smaller than the maximum number of participants by which the event can be held is judged to exist (Step S14: YES).

In Step S15, the proposal unit 143 sends the reservation change proposal mail to the user reserving the user-shortage-reservation frame recommending changing the reservation to a reservation of the event holding conditions-satisfying reservation frame. More specifically, the proposal unit 143 determines one or more combination of the releasing reservation frame and the receiving reservation frame, from among the user-shortage-reservation frames found in Step S11 and the event holding conditions-satisfying reservation frames found in Step S13. In this case, the proposal unit 143 uses the user-shortage-reservation frame as the releasing reservation frame and the event holding conditions-satisfying reservation frame as the receiving reservation frame. In addition, the proposal unit 143 determines a combination so that a total amount of the number of reservation users of the releasing reservation frame and the number of reservation users of the receiving reservation frame is equal to or smaller than the maximum number of participants by which the event can be held. After determination of the combination, the proposal unit 143 acquires the reservation list of the releasing reservation frame from the reservation situation DB 12c. Then, the proposal unit 143 searches for the reservation information corresponding to the reservation number registered in the reservation list, from the reservation information DB 12d. Then, the proposal unit 143 acquires the mail address, etc. of the proposal-subjected user from the member information registered in the member information DB 12a in association with the user ID included in the reservation information. Then, the proposal unit 143 creates the reservation change proposal mail. In this case, the proposal unit 143 adds the mail address of the proposal-subjected user, to the recipients' addresses of the reservation change proposal mail. In addition, the proposal unit 143 adds a message to propose to change the reservation, to the body of the reservation change proposal mail. Further, the proposal unit 143 adds the tee-off time of the receiving reservation frame which is combined to the releasing reservation frame reserved by the proposal-subjected user, to the body of the reservation change proposal mail. The proposal unit 143 sends the created reservation change proposal mail. The proposal unit 143 performs the creating and sending of the reservation change proposal mail, for each proposal-subjected user. After completion of the processing of Step S15, the proposal unit 143 terminates the reservation change proposal processing in one front/back nine.

According to the embodiment of the present invention as described above, the system control unit 14 acquires, for each time frame, the number of reservation users of the time frame which is the single person reservation frame in which the minimum number of participants by which the event can be held, and the maximum number of participants by which the event can be held have been set. Then, when there exists, in reserved time frames, the user-shortage-reservation frame in which the number of reservation users is smaller than the minimum number of participants by which the event can be held, the system control unit 14 searches for the changeable-number-of-users-frame in which a total amount of the number of reservation users of this frame and the number of at least part of the users reserving the user-shortage-reservation frame, from among the time frames in which the number of reservation users is smaller than the maximum number of participants by which the event can be held, of the reserved time frames. Then, when the changeable-number-of-users-frame has been found, the system control unit 14 acquires, from the storage unit 12, the user ID of the user reserving the time frame which is one of the user-shortage-reservation frame and the changeable-number-of-users-frame and is a time frame in which the number of reservation users is smaller than the minimum number of participants by which the event can be held. Then, the system control unit 14 outputs, based on the user ID as acquired, the information of giving the user identified by the user ID a proposal to changing the reservation to a reservation of the time frame, of the user-shortage-reservation frame and the changeable-number-of-users-frame, which has not been reserved by the user identified by the user ID. Therefore, the change of the reservation by the user who has been proposed to change the reservation enables reduction of the risk that a reservation is automatically cancelled by failure in collecting finally users the number of whom is equal to or larger than the minimum number of participants by which the event can be held.

In addition, the system control unit 14 searches for, as the receiving reservation frame, the event holding conditions-satisfying reservation frame in which the number of reservation users is smaller than the maximum number of participants by which the event can be held. Then, the system control unit 14 outputs the information of giving to the user reserving the user-shortage-reservation frame a proposal to change the reservation. As a result, the user originally reserving the receiving reservation frame can participate in the game of golf, even when the user who has been proposed to change the reservation does not change the reservation. In addition, it is possible to achieve a higher probability that the user who has been proposed to change the reservation and changed the reservation can participate in the game of golf.

### [1-6. Modification Examples]

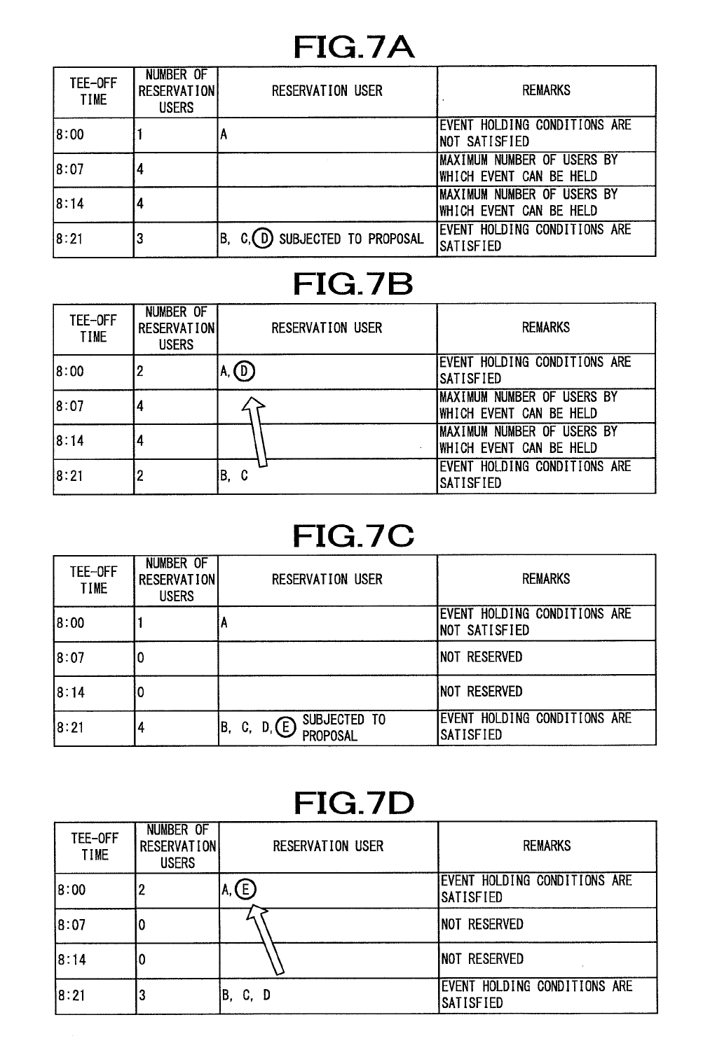

Now, modification examples of the embodiment of the present invention will be described with the use of FIG. 7. The golf course reservation server 1 may determine the event holding conditions-satisfying reservation frame as the releasing reservation frame, and determine the user-shortage-reservation frame as the receiving reservation frame. More specifically, the golf course reservation server 1 searches for, as the releasing reservation frame, the event holding conditions-satisfying reservation frames in which the difference between the number of reservation users of the event holding conditions-satisfying reservation frames and the minimum number of participants, by which the event can be held, of the event holding conditions-satisfying reservation frames is equal to or larger than the difference between the number of reservation users of the user-shortage-reservation frame and the minimum number of participants, by which the event can be held, of the user-shortage-reservation frame, from among the event holding conditions-satisfying reservation frames in which the number of reservation users is larger than the minimum number of participants by which the event can be held. The difference between the number of reservation users of the event holding conditions-satisfying reservation frames and the minimum number of participants, by which the event can be held, of this frame may be referred to as the “surplus number of reservation users”. The difference between the number of reservation users of the user-shortage-reservation frame and the minimum number of participants, by which the event can be held, of this frame may be referred to as the “shortage number of reservation users”. The golf course reservation server 1 determines, as the proposal-subjected users, the users the number of whom is equal to or larger than the shortage number of reservation users of the user-shortage-reservation frame, of the users reserving the event holding conditions-satisfying reservation frame found as the releasing reservation frame. If users, of the users proposed to change the reservation, the number of whom is the shortage number of reservation has changed the reservations to reservations of the user-shortage-reservation frame.

For example, the event holding conditions-satisfying reservation frame having a relationship of the minimum number of participants by which the event can be held<the number of reservation users<the maximum number of participants by which the event can be held allows increasing the number of reservation users to the maximum number of participants by which the event can be held, and decreasing the number of reservation users to the minimum number of participants by which the event can be held. Therefore, the golf course reservation server 1 may determine the event holding conditions-satisfying reservation frame satisfying such conditions as any one of the receiving reservation frame and the releasing reservation frame. FIG. 3 shows an example of determining the event holding conditions-satisfying reservation frame as the receiving reservation frame. Upon determining the event holding conditions-satisfying reservation frame as the releasing reservation frame, the golf course reservation server 1 calculates the surplus number of reservation users. The golf course reservation server 1 determines a combination of the event holding conditions-satisfying reservation frame to become the releasing reservation frame and the user-shortage-reservation frame to become the receiving reservation frame so that a total amount of the surplus number of reservation users and the number of reservation users of the user-shortage-reservation frame is equal to or larger than the minimum number of participants, by which the event can be held, of the user-shortage-reservation frame. Then, the golf course reservation server 1 determines, as the proposal-subjected user, users, of the users reserving the event holding conditions-satisfying reservation frame, the number of whom is the surplus number of reservation users.

FIG. 7A is an example of a situation of reservation in a case where the event holding conditions-satisfying reservation frame in which the number of the reservation users is smaller than the maximum number of participants by which the event can be held is used as the releasing reservation frame. In the example of FIG. 7, it is assumed that the minimum number of participants by which the event can be held is two and the maximum number of participants by which the event can be held is four, for all the time frames. As shown in FIG. 7A, the number of reservation users in the time frame at 8:00 is one. The reservation user is the user A. The number of reservation users in the time frame at 8:21 is three. The reservation users are the users B to D. A total amount of the number of reservation users in the time frame at 8:00 and the surplus number of reservation users in the time frame at 8:21 is two. So, the golf course reservation server 1 determines the time frame at 8:00 as the receiving reservation frame and determines the time frame at 8:21 as the releasing reservation sot. In this case, the golf course reservation server 1 determines the user D as the proposal-subjected user, for example.

FIG. 7B is an example of a situation of reservation after the change of the reservation. It is assumed that the user D who has been proposed to change the reservation cancelled the reservation of the time frame at 8:21 and reserved the time frame at 8:00. In this case, each of the number of reservation users of the time frame at 8:00 and the number of reservation users of the time frame at 8:21 become two, as shown in FIG. 7B. As a result, both of the time frames satisfy the event holding conditions. Therefore, each of the users A to D can play golf.

Alternatively, the event holding conditions-satisfying reservation frame having a relationship of the minimum number of participants by which the event can be held<the number of reservation users=the maximum number of participants by which the event can be held allows decreasing the number of reservation users to the minimum number of participants by which the event can be held. Thus, the golf course reservation server 1 may determine the reservation frame satisfying such conditions as the releasing reservation frame. Also in this case, the golf course reservation server 1 determines a combination of the event holding conditions-satisfying reservation frame to become the releasing reservation frame and the user-shortage-reservation frame to become the receiving reservation frame so that a total amount of the surplus number of reservation users and the number of reservation users of the user-shortage-reservation frame is equal to or larger than the minimum number of participants by which the event can be held.

FIG. 7C is an example of a situation of reservation in a case where the event holding conditions-satisfying reservation frame in which the number of reservation users reaches the maximum number of participants by which the event can be held is used as the releasing reservation frame. As shown in FIG. 7C, the number of reservation users in the time frame at 8:00 is one. The reservation user is the user A. The number of reservation users in the time frame at 8:21 is four. The reservation users are the users B to E. A total amount of the number of reservation users in the time frame at 8:00 and the surplus number of reservation users in the time frame at 8:21 is three. So, the golf course reservation server 1 determines the time frame at 8:00 as the receiving reservation frame and determines the time frame at 8:21 as the releasing reservation sot. In addition, the golf course reservation server 1 determines for example the user E as the proposal-subjected user. Since the surplus number of reservation users is two, the golf course reservation server 1 may determine the two of them as the proposal-subjected user.

When the difference between the number of reservation users of the user-shortage-reservation frame and the maximum number of participants, by which the event can be held, of the user-shortage-reservation frame is equal to or smaller than the surplus number of reservation users of the event holding conditions-satisfying reservation frame, the golf course reservation server 1 may determine all the users reserving the event holding conditions-satisfying reservation frame as the proposal-subjected user. The reason for it is that only users, of the users reserving the event holding conditions-satisfying reservation frame, the number which is the difference between the number of reservation users of the user-shortage-reservation frame and the maximum number of participants, by which the event can be held, of this frame, can change the reservations to a reservations of the user-shortage-reservation frame. In sum, the number of reservation users of the event holding conditions-satisfying reservation frame does not become less than the minimum number of participants by which the event can be held.

FIG. 7D is an example of a situation of reservation after the change of the reservation. It is assumed that the user E who has been proposed to change the reservation cancelled the reservation of the time frame at 8:21 and reserved the time frame at 8:00. In this case, the number of reservation users of the time frame at 8:00 becomes two, and the number of reservation users of the time frame at 8:21 becomes three, as shown in FIG. 7D. As a result, both of the time frames satisfy the event holding conditions. Therefore, each of the users A to E can play golf.

Upon determining only a part of the users of a plurality of users reserving the releasing reservation frames as the proposal-subjected user, the golf course reservation server 1 may freely determine the proposal-subjected user. In addition, the golf course reservation server 1 may determine the user having a higher probability of changing the reservation as the proposal-subjected user, as already described.

When the user-shortage-reservation frame is used as the receiving reservation frame, the golf course reservation server 1 performs the reservation change proposal processing, for example before the holding-event-determination time. The reason for it is that the user-shortage-reservation frame, which is to be used as the receiving reservation frame, does not exist at the holding-event-determination time, due to the automatic cancellation of the user-shortage-reservation frame.

### 2. Second Embodiment of the Present Invention

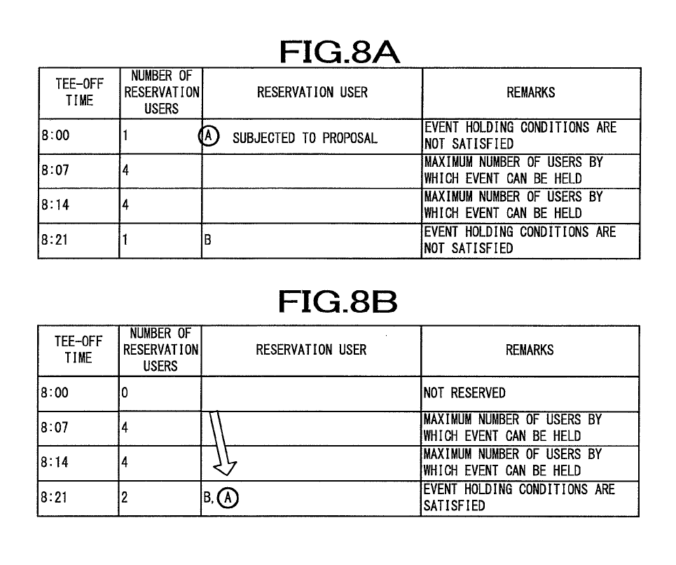

Now, the second embodiment of the present invention will be described with the use of FIG. 8 to FIG. 10. In this embodiment of the present invention, the golf course reservation server 1 determines the receiving reservation frame from among the user-shortage-reservation frames. The user-shortage-reservation frame, which has a relationship of the number of reservation users<the minimum number of participants by which the event can be held≦the maximum number of participants by which the event can be held, can either increase the number of reservation users to the number which is equal to or larger than the minimum number of participants by which the event can be held, or decrease the number of reservation users to increase the number of reservation users of another user-shortage-reservation frame. If the user-shortage-reservation frame has been judged to exist, the golf course reservation server 1 searches for a combination of the user-shortage-reservation frames in which a total number of reservation users becomes equal to or larger than the minimum number of participants by which the event can be held, of any one of the user-shortage-reservation frames. The number of reservation frames included in the combination may be two, or three or more. The golf course reservation server 1 determines the releasing reservation frame and the receiving reservation frame from among the user-shortage-reservation frames included in the combination. In this case, the golf course reservation server 1 determines, for example, one of the user-shortage-reservation frames as the receiving reservation frame, and the other one or more user-shortage-reservation frames as the releasing reservation frame. In this embodiment of the present invention, the golf course reservation server 1 performs the reservation change proposal processing, for example before the holding-event-determination time. The reason for it is the same as described in the modification examples of the first embodiment of the present invention.

FIG. 8A is an example of a situation of reservation in a case where the user-shortage-reservation frame is used as the releasing reservation frame. It is assumed that the minimum number of participants by which the event can be held is two, and the maximum number of participants by which the event can be held is four, in the example of FIG. 8. FIG. 8A is view showing the example of a situation of reservation. As shown in FIG. 8A, the number of reservation users of the time frame at 8:00 is one. The reservation user is the user A. The number of reservation users of the time frames at 8:07 and at 8:14 is four. The number of reservation users of the time frame at 8:21 is one. The reservation user is the user B. The time frames at 8:00 and at 8:21 are the user-shortage-reservation frame. When time has then come to the holding-event-determination time, with the reservation condition unchanged, the reservation of the time frames at 8:07 and at 8:21 will be cancelled. Therefore, neither the user A nor the user B can play golf. In addition, there exist two time frames in which events of golf will not be held. In this case, the change of the reservation by any one of the users A and B to a reservation of the time frame reserved by the other of them would cause the time frame to which the reserved time frame is to be changed to satisfy the event holding conditions. Thus, the golf course reservation server 1 may determine any one of these users as the proposal-subjected user. It is assumed that the golf course reservation server 1 determines, for example, the time frame at 8:00 as the releasing reservation frame, and the time frame at 8:21 as the receiving reservation frame. As a result, the golf course reservation server 1 sends the reservation change proposal mail to the user A.

FIG. 8B is an example of a situation of reservation after the change of the reservation. It is assumed that the user A who viewed the reservation change proposal mail cancelled the reservation of the time frame at 8:00 and reserved the time frame at 8:21. In this case, the number of reservation users of the time frame at 8:21 becomes two, as shown in FIG. 8B. The time frame at 8:21 satisfies the event conditions after the change of reservation. Accordingly, the both of the users A and B can play golf. In addition, the number of time frames in which the event of golf will not be held can be reduced to one.

The golf course reservation server 1 may determine one user-shortage-reservation frame as the releasing reservation frame, and a plurality of user-shortage-reservation frames as the receiving reservation frames. In this case, the golf course reservation server 1 only has to search for the receiving reservation frame so that, for example, the number of a part of the reservation users reserving the user-shortage-reservation frame which is to become the releasing reservation frame is equal to or larger than the minimum number of participants, by which the event can be held, of the user-shortage-reservation frame which is to become the receiving reservation frame. It is assumed for example that each of the minimum number of participants by which the event can be held and the maximum number of participants by which the event can be held is four. In addition, it is assumed that there exists one time frame X having the number of reservation users of two, and there exist time frames Y and Z each having the number of reservation users of three. Here, if any one of the users reserving the time frame changes the reservation to a reservation of the time frame Y and the other user changes the reservation to a reservation of the time frame Z, all of the users reserving the time frames Y and Z can play golf.

The golf course reservation server 1 may freely determine the releasing reservation frame and the receiving reservation frame from among the user-shortage-reservation frames included in the combination. Alternatively, the golf course reservation server 1 may determine the releasing reservation frame and the receiving reservation frame based on predetermined conditions. The golf course reservation server 1 may determine, for example, the releasing reservation frame and the receiving reservation frame so that the change of the reservation from the releasing reservation frame to the receiving reservation frame provides a higher probability that the number of reservation users of the receiving reservation frame is equal to or larger than the minimum number of participants by which the event can be held. Examples of such a method of determining the releasing reservation frame and the receiving reservation frame will be described below.

### (1) Method Based on Reservation Date and Time

There is a higher probability that, the earlier the reservation date and time, the keener the user wishes to play golf at the reserved time frame. On the other hand, there is a higher probability that, the later the reservation date and time, the more flexible the user handles the change of the plan of playing golf. Thus, the golf course reservation server 1 may determine, as the receiving reservation frame, the user-shortage-reservation frame which has been reserved at the earliest date among the user-shortage-reservation frames included in the combination, and determine the other user-shortage-reservation frame as the releasing reservation frame.

### (2) Method Based on the Number of Reservation Users

In general, the larger the difference between the number of reservation users of the user-shortage-reservation frame, and the minimum number of participants by which the event can be held, there is a lower probability that that user-shortage-reservation frame becomes the event holding conditions-satisfying reservation frame. The reason for it is that the larger the difference, the more increased number of the users is required to change the reservation. Thus, the golf course reservation server 1 may determine, as the receiving reservation frame, the user-shortage-reservation frame which has the smallest difference between the number of reservation users and the minimum number of participants by which the event can be held, among the user-shortage-reservation frames included in the combination, and determine the other user-shortage-reservation frame as the releasing reservation frame.

(3) Method Based on Accessibility with which the User can Reach a Golf Course

A user whose address is located near a golf course is apt to have a higher probability of flexibly handling the change of the plan of golf. If such a user is proposed to change the reservation, there is a higher probability that they may change the reservation. Thus, the golf course reservation server 1 may determine, as the receiving reservation frame, the user-shortage-reservation frame which has been reserved by the user having the hardest accessibility with which the user can reach a golf course among the user-shortage-reservation frames included in the combination, and determine the other user-shortage-reservation frame as the releasing reservation frame. The golf course reservation server 1 may use, as the index with which the accessibility may be determined, for example, a straight-line distance, a travel distance, a travel time, etc. between a place of residence to a golf course.

### (4) Method Based on Operation History

The golf course reservation server 1 may determine the releasing reservation frame and the receiving reservation frame based on a search history of a golf course, a browsing history of the time frame detail page, etc.

When a user searches for, for example, a golf course, he/she may specify the desired tee-off time period as a search condition. There is a higher probability that a user wishes to start playing golf within the desired tee-off time period rather than the other periods of time. Consequently, if a user has reserved the time frame within the desired tee-off time period, there is a lower probability that the user may change the reservation to a reservation of a time frame outside the desired tee-off time period. On the other hand, even if the time frame within the desired tee-off time period has been reserved, a probability with which a user may change the reservation to a reservation of another time frame within the desired tee-off time period is higher than a probability with which a user may change the reservation to a reservation of a time frame outside the desired tee-off time period.

A user browses the time frame detail page before reserving the time frame. If a user has browsed only the time frame detail page of the reserved time frame, there is a high probability that the user wishes to play golf in the reserved time frame. Accordingly, the user is apt to have a low probability of changing the reservation, even when the user is proposed to change the reservation to another time frame. On the other hand, if a user has browsed the time frame detail page of another time frame other than the reserved time frame, and then been proposed to change the reservation to a time frame corresponding to the browsed time frame detail page, the user is apt to have a high probability of changing the reservation.

Thus, the golf course reservation server 1 may judges a probability with which each user reserving the user-shortage-reservation frame included in the combination may change the reservation to a reservation of the other user-shortage-reservation frame, based on at least one of the search history and the browsing history of the time frame detail page. Then, the golf course reservation server 1 may determine, as the user-shortage-reservation frame, the user-shortage-reservation frame which has been reserved by the user having the lowest probability of changing the reservation to a reservation of the other user-shortage-reservation frame and determine the other user-shortage-reservation frame as the releasing reservation frame, for example.

The golf course reservation server 1 may determine the proposal-subjected user, for example based on a combination of at least two methods of the methods described in items (1) to (4) above. Alternatively, the golf course reservation server 1 may determine, as the proposal-subjected users, all the users reserving the user-shortage-reservation frames included in the combination without determining the releasing reservation frame and the receiving reservation frame. In this case, the golf course reservation server 1 may propose each user to change the reservation to a reservation of the different user-shortage-reservation frame from the user-shortage-reservation frame reserved by the user. In this case, it is sufficient that any one of users would change the reservation and the thereby the number of reservation users of any one of the user-shortage-reservation frames becomes equal to or larger than the minimum number of participants by which the event can be held. In this case, the golf course reservation server 1 may be configured to be capable of, for example, making adjustment between the users as to who should change the reservation. Alternatively, the golf course reservation server 1 may be configured to be capable of, for example, making adjustment as to whom the golf course provider proposes to change the reservation.

There is a possibility that the both of the user-shortage-reservation frame and the event holding conditions-satisfying reservation frame exist as the changeable-number-of-users-frames. In this case, any one of a combination of the user-shortage-reservation frames, and a combination of the user-shortage-reservation frame and the event holding conditions-satisfying reservation frame may be selected as the combination of the releasing reservation frame and the receiving reservation frame. The golf course reservation server 1 may preferentially extract for example the combination of the user-shortage-reservation frames. Then, if the user-shortage-reservation frames cannot be combined, the golf course reservation server 1 may combine the user-shortage-reservation frame and the event holding conditions-satisfying reservation frame. Alternatively, the golf course reservation server 1 may preferentially extract for example the combination of the user-shortage-reservation frame and the event holding conditions-satisfying reservation frame. Then, if the user-shortage-reservation frame and the event holding conditions-satisfying reservation frame cannot be combined, the golf course reservation server 1 may combine the user-shortage-reservation frames.

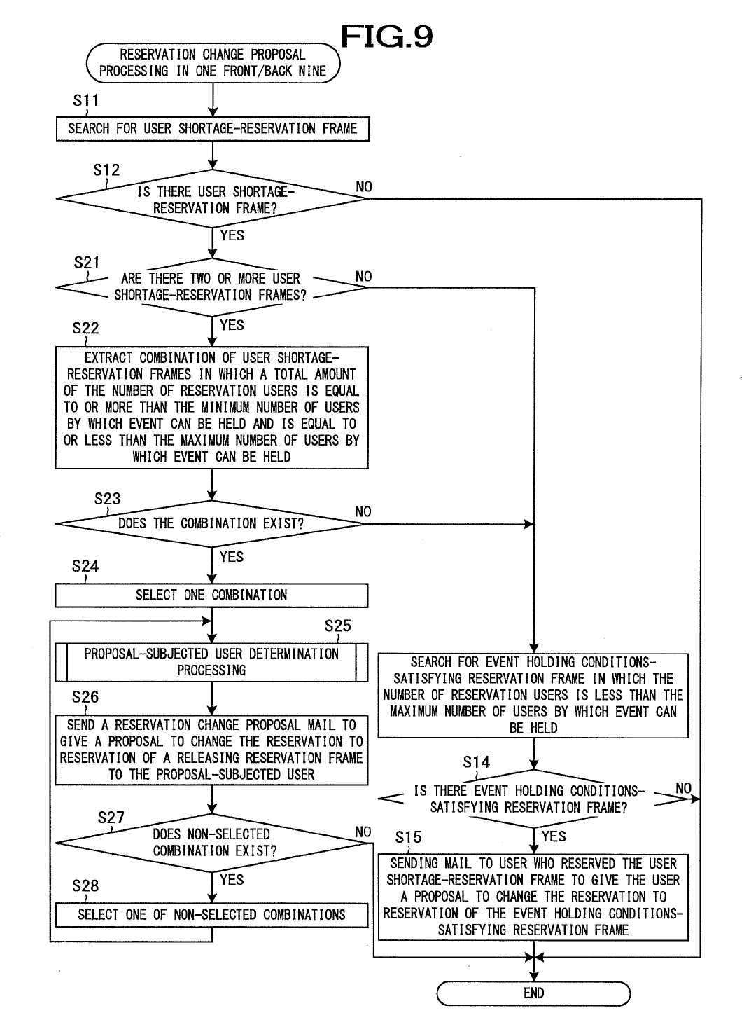

FIG. 9 is a flowchart showing an example of the reservation change proposal processing in one front/back nine by the system control unit 14 of the golf course reservation server 1 according to the embodiment of the present invention. In FIG. 9, steps which are the same as those in FIG. 6 have the same reference numerals as those in FIG. 6. As shown in FIG. 9, Step S11 and Step S12 are performed first. In Step S12, the user-shortage-reservation frame-determining unit 141 proceeds to Step S21, when the user-shortage-reservation frame is judged to exist (Step S12: YES).

In Step S21, the user-shortage-reservation frame-determining unit 141 judges if two or more user-shortage-reservation frame exit. In this case, the user-shortage-reservation frame-determining unit 141 proceeds to Step S13, when the number of the user-shortage-reservation frames is judged to be less than two (Step S21: NO). Then, Step S13-S15 are performed. On the other hand, the user-shortage-reservation frame-determining unit 141 proceeds to Step S22, when two or more user-shortage-reservation frames are judged to exist (Step S21: YES).

In Step S22, the changeable-number-of-user-reservation frame-determining unit 142 extracts combinations of the user-shortage-reservation frames in which a total amount of the reservation users is equal to or larger than the minimum number of participants by which the event can be held, and equal to or smaller than the maximum number of participants by which the event can be held. Then, the changeable-number-of-user-reservation frame-determining unit 142 judges if the corresponding combination exists (Step S23). In this case, the changeable-number-of-user-reservation frame-determining unit 142 proceeds to Step S13, when the corresponding combination is not judged to exist (Step S23: NO). On the other hand, the changeable-number-of-user-reservation frame-determining unit 142 proceeds to Step S24, when the corresponding combination is judged to exist (Step S23: YES).

In Step S24, the proposal unit 143 selects one combination from the extracted combinations. Then, the proposal unit 143 performs a proposal-subjected user determination processing (Step S25). The proposal-subjected user determination processing is a processing of determining the releasing reservation frame and the receiving reservation frame from among the user-shortage-reservation frames included in the selected combination, and determining the proposal-subjected user. The detail of the proposal-subjected user determination processing will be described later. Then, the proposal unit 143 sends, to the user determined as the proposal-subjected user, a reservation change proposal mail proposing to change the reservation to a reservation of the user-shortage-reservation frame determined as the receiving reservation frame (Step S26). The specific contents of the processing to send the reservation change proposal mail are the same as those in Step S15.

Then, the proposal unit 143 judges if the combinations extracted include a combination which has not still been selected (Step S27). In this case, the proposal unit 143 proceeds to Step S28, when the combination which has not still been selected is judged to exist (Step S27: YES). In Step S28, the proposal unit 143 selects one combination from the combinations which have not still been selected. Then, the proposal unit 143 proceeds to Step S25. On the other hand, the proposal unit 143 terminates the reservation change proposal processing in one front/back nine, when all the combinations are judged to be selected (Step S27: NO).

Now, description will be given of the proposal-subjected user determination processing by the system control unit 14 of the golf course reservation server 1. The contents of the proposal-subjected user determination processing defer depending on the determination method of the proposal-subjected user. So, the proposal-subjected user determination processing will be described below for each determination method.

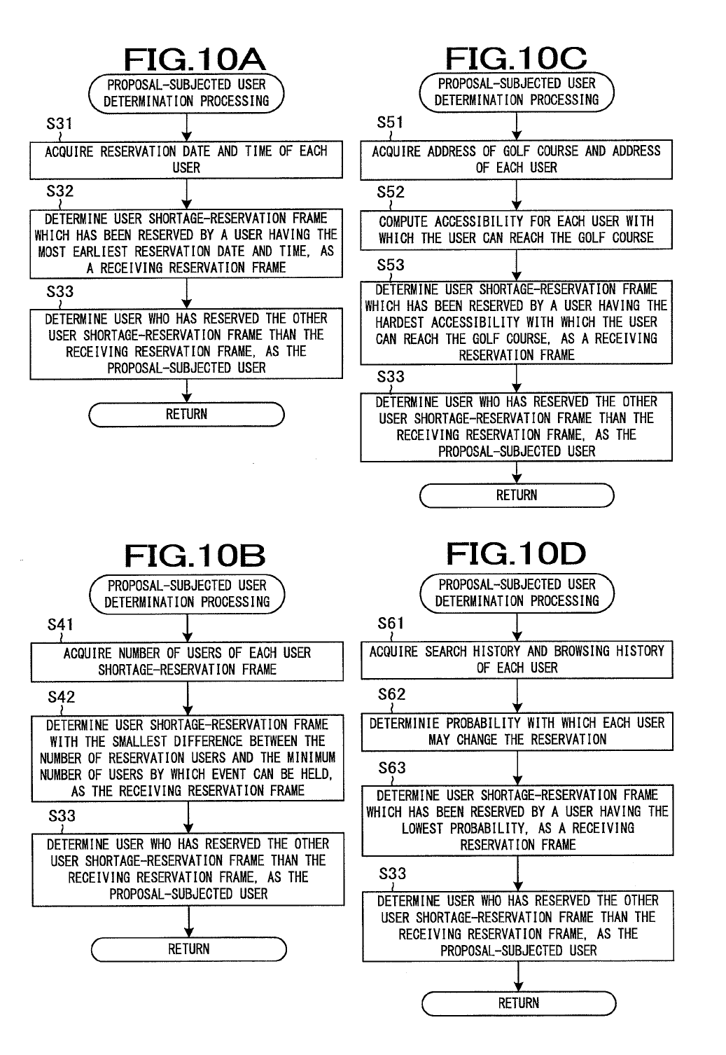

FIG. 10A is a flowchart showing a processing example of a proposal-subjected user determination processing in a case where the proposal-subjected user is determined based on the reservation date and time. As shown in FIG. 10A, the proposal unit 143 acquires the reservation date and time of each of users reserving the respective time frames included in the selected combinations (Step S31). More specifically, the proposal unit 143 searches for the reservation information corresponding to the reservation number registered in the reservation list corresponding to the time frame, from the reservation information DB 12d. Then, the proposal unit 143 acquires the reservation date and time from the reservation information. Then, the proposal unit 143 specifies the earliest reservation date and time from the acquired reservation dates and times. The proposal unit 143 determines the time frame which has been reserved at the most earliest date and time, as the receiving reservation frame (Step S32). Then, the proposal unit 143 determines, as the releasing reservation frame, the other time frame than the receiving reservation frame, of the time frames included in the selected combination. The proposal unit 143 determines a user who has reserved the releasing reservation frame as the proposal-subjected user (Step S33). The proposal unit 143 terminates the proposal-subjected user determination processing after completion of the processing of Step S33.

FIG. 10B is a flowchart showing a processing example of the proposal-subjected user determination processing in a case where the proposal-subjected user is determined based on the number of reservation users. In FIG. 10B, the same steps which are the same as those in FIG. 10A have the same reference numerals as those in FIG. 10A. As shown in FIG. 10B, the proposal unit 143 acquires the number of reservation users of each time frame included in the selected combination (Step S41). Then, the proposal unit 143 specifies the time frame having the smallest difference between the number of reservation users and the minimum number of participants by which the event can be held, of the time frames included in the combination. The proposal unit 143 determines the time frame having the smallest difference as the receiving reservation frame (Step S42). Then, the proposal unit 143 performs Step S33 to determine the proposal-subjected user.

FIG. 10C is a flowchart showing a processing example of the proposal-subjected user determination processing in a case where the proposal-subjected user is determined based on accessibility with which the user can reach a golf course. In FIG. 10C, the same steps which are the same as those in FIG. 10A have the same reference numerals as those in FIG. 10A. As shown in FIG. 10C, the proposal unit 143 acquires an address of a corresponding golf course from the golf course information DB 12b. In addition, the proposal unit 143 acquires addresses of the users reserving the respective time frames included in the elected combination (Step S51). More specifically, the proposal unit 143 searches for the reservation information corresponding to the reservation number registered in the reservation list corresponding to the time frame, from the reservation information DB 12d. The proposal unit 143 acquires the address from the member information registered in the member information DB 12a in association with the user ID included in the reservation information. Then, the proposal unit 143 calculates, for each user, the index indicative of the accessibility with which the user can reach the golf course from the place of residence, based on the acquired address (Step S52). The proposal unit 143 calculates, for example, the straight-line distance from the place of residence to the place of the golf course. Then, the proposal unit 143 compares the calculated indexes to each other. Then, the proposal unit 143 specifies the user having the hardest accessibility with which the user can reach the golf course, based on the results of comparison. For example, the proposal unit 143 specifies the user having the longest straight-line distance to the place of the golf course. Then, the proposal unit 143 determines the time reserved by the user having the hardest accessibility with which the user can reach the golf course, as the receiving reservation frame (Step S53). Then, the proposal unit 143 performs Step S33 to determine the proposal-subjected user.

FIG. 10D is a flowchart showing a processing example of the proposal-subjected user determination processing in a case where the proposal-subjected user is determined based on an operation history. In FIG. 10D, the same steps which are the same as those in FIG. 10A have the same reference numerals as those in FIG. 10A. As shown in FIG. 10D, the proposal unit 143 acquires search histories and browsing histories of users who have reserved respective time frame included in the selected combination (Step S61). More specifically, the proposal unit 143 searches for the reservation information corresponding to the reservation number as registered in the reservation list corresponding to the time frame, from the reservation information DB 12d. Then, the proposal unit 143 acquires the user ID and the reservation date and time from the reservation information. Then, the proposal unit 143 searches for the operation histories including the acquired user ID from the operation history DB 12e. Then, the proposal unit 143 extracts a history of log-in to the reservation site from the found operation histories. Then, the proposal unit 143 acquires the operation date and time of the extracted history as the log-in date and time. When, there exists a plurality of log-in histories, the proposal unit 143 selects, from the plurality of log-in dates and hours, the log-in date and time which is the prior to the reservation date and time, and closest to the reservation date and time. Then, the proposal unit 143 extracts the search histories and the browsing histories of the time frame detail pages, from the operation histories in which the operation dates and times is included in a period of time from the log-in date and time to the reservation date and time. The log-in date and time is the date and time at which the user has started to use the reservation site. Accordingly, the proposal unit 143 acquires the histories of operations which have been carried out by the user during a period of time from the start of use of the reservation site by the user to the reservation of the time frame. The proposal unit 143 acquires the search histories and the browsing histories for each user reserving the time frame.

Then, the proposal unit 143 determines probability with which each user may change the reservation, based on the history as acquired (Step S62). The proposal unit 143 calculates, for example, a score indicative of the probability of changing the reservation. For example, the higher the score, the higher the probability. The proposal unit 143 selects one of the users reserving the time frames included in the selected combination. Then, the proposal unit 143 sets the score of the selected user to for example “0”. Then, the proposal unit 143 acquires the tee-off time of the time frame which has not been reserved by the selected user, from the time frames included in the selected combination. This tee-off time may be referred to as the “non-reserved tee-off time”.

Then, the proposal unit 143 acquires a specified desired tee-off time period from the search history of the selected user. When there is a plurality of search histories, the proposal unit 143 acquires the desired tee-off time period from each search history. In this case, the proposal unit adds a preset first addition value to the score, when the search history does not include the desired tee-off time period. The reason for it is that the user who has not specified the desired tee-off time period has a higher probability of changing the reservation than the user who has specified the desired tee-off time period. Then, the proposal unit 143 adds a preset second addition value to the score, when the non-reserved tee-off time is included in any of the desired tee-off time periods. The reason for it is that there is a higher probability that the user may change the reservation to rather the time frame within the desired tee-off time period, than the time frame outside the desired tee-off time period. Then, the proposal unit 143 adds a preset third addition value to the score, when the tee-off time of the time frame which has been reserved by the user as selected is not included in any of the desired tee-off time periods. The reason for it is that the user who has reserved the time frame outside the desired tee-off time period has a higher probability of changing the reservation than the user who has reserved the time frame within the desired tee-off time period.

Then, the proposal unit 143 acquires the tee-off time of the time frame whose information has browsed by the user, from the browsing history of the selected user. When a plurality of browsing histories exits, the proposal unit 143 acquires the tee-off time from each browsing history. Then, the proposal unit 143 adds a preset fourth addition value to the score, when at least any of the tee-off times of the time frames whose information has browsed by the user is the same as the non-reservation tee-off time. The reason for it is that there is a high probability with which the user wishes to play golf at a time frame in which the user has browsed the information.

The proposal unit 154 selects sequentially the user to calculate the score. Each of the first to fourth addition values may be set to a value freely determined. The method described herein is an example of a method of determining probability of changing the reservation based on the operation history. The proposal unit 143 may determine the probability of changing the reservation in another manner based on the operation history.

Then, the proposal unit 143 compares the calculated score between the users. Then, the proposal unit 143 specified the user having the lowest score. The proposal unit 143 determines the user-shortage-reservation frame which has been reserved by the user having the lowest score, as the receiving reservation frame (Step S63). Then, the proposal unit 143 performs Step S33 to determine the proposal-subjected user.

According to the embodiment of the present invention as described above, when there exists a user-shortage-reservation frame, the system control unit 14 searches for, as the changeable-number-of-users-frame, another user-shortage-reservation frame in which a total amount of the reservation users of these user-shortage-reservation frames is equal to or larger than the minimum number of participants by which the event can be held. Then, the system control unit 14 acquires the user ID of the user who has reserved any one of the user-shortage-reservation frame, and outputs the information of giving a proposal to change the reservation. Therefore, it is possible for each of users who have reserved the plurality of user-shortage-reservation frames to participate in the game of golf. In addition, the number of reservation frames which are to be cancelled can be reduced.

In addition, the system control unit 14 acquires the reservation date and time of each of users who have reserved the respective user-shortage-reservation frame from the storage unit 12. Then, the system control unit 14 outputs the information of giving a proposal to change the reservation to the user having the later reservation date and time, of the users reserving the user-shortage-reservation frames. It is therefore possible to provide a higher probability that the number of reservation users of the receiving reservation frame becomes equal to or larger than the minimum number of participants by which the event can be held.

Alternatively, the system control unit 14 outputs the information of giving a proposal to change the reservation to the user who have reserved the time frame having a larger difference between the number of reservation users and the minimum number of participants by which the event can be held, of the user-shortage-reservation frames. It is therefore possible to provide a higher probability that the number of reservation users of the receiving reservation frame becomes equal to or larger than the minimum number of participants by which the event can be held.

Alternatively, the system control unit 14 acquires the addresses of the users who have reserved the respective user-shortage-reservation frames, from the storage unit 12. Then, the system control unit 14 makes a comparison in accessibility with which the user reserving the user-shortage-reservation frame can reach a golf course, based on the acquired addresses. Then, the system control unit 14 outputs, based on the comparison results, the information of giving a proposal to change the reservation to the user having the easier accessibility with which the user can reach the golf course, of the users reserving the user-shortage-reservation frames. It is therefore possible to provide a higher probability that the number of reservation users of the receiving reservation frame becomes equal to or larger than the minimum number of participants by which the event can be held.

Alternatively, the system control unit 14 acquires the operation histories of the users reserving the respective user-shortage-reservation frames, from the storage unit 12. Then, the system control unit 14 makes a comparison in probability that the user reserving the user-shortage-reservation frame may change the reservation, based on the operation history as acquired. Then, the system control unit 14 outputs, based on the comparison results, the information of giving a proposal to change the reservation to the user having the higher probability, of the users reserving the user-shortage-reservation frames. It is therefore possible to provide a higher probability that the number of reservation users of the receiving reservation frame becomes equal to or larger than the minimum number of participants by which the event can be held.

In each of the embodiments of the present invention as described above, the present invention is applied to the golf as the event. However, the present invention may be applied to an event which is different from the golf.

In addition, in each of the embodiments of the present invention as described above, the information processing apparatus of the present invention is applied to the server device in a client server system. However, the information processing apparatus of the present invention may be applied to the other information processing device than the server device. For example, the information processing apparatus of the present invention may be applied to the user terminal 3, etc. Then, for example, a control unit included in the information processing apparatus may functions as the means in the present invention and thereby the control unit may outputs the information according to the present invention to a display means such as a display, etc. In this case, the display means may be provided by the information processing apparatus. Alternatively, the display means may be an independent device from the information processing apparatus.

### DESCRIPTION OF REFERENCE NUMERALS

1 Golf course reservation server
2 Golf course terminal
3 User terminal
11 Communication unit
12 Storage unit
12a Member information DB
12b Golf course information DB
12c Reservation situation DB
12d Reservation information DB
12e Operation history DB
13 Input and output interface
14 System control unit
14a CPU
14b ROM
14c RAM
15 System bus
141 User-shortage-reservation frame-determining unit
142 Changeable-number-of-user-reservation frame-determining unit
143 Proposal unit
NW Network
S Information processing system

1-12. (canceled)

13. An information processing apparatus comprising:
at least one memory operable to store program instructions;
at least one processor operable to access said memory, read said program instructions, and operate according to said program instructions, said program instructions comprising:
number-of-users-acquisition instructions that cause at least one of said at least one processors to acquire, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
search instructions that cause at least one of said at least one processors to, when reservation frames which are reserved include a first reservation frame in which the number of users acquired is smaller than the minimum number of users, search for a second reservation frame in which the number of users acquired is smaller than the maximum number of users and a total amount of the number of users reserving the second reservation frame and a number of at least part of the users reserving the first reservation frame is equal to or larger than the minimum number of users, from among the reservation frames which are reserved;
identification information acquisition instructions that cause at least one of said at least one processors to, when the second reservation frame is found, acquire from a storage that stores identification information for identifying a user in association with a reservation frame reserved by the user, identification information of a user reserving a reservation frame which is any one of the first reservation frame and the second reservation frame, the number of users of the any one acquired being smaller than the minimum number of users of the any one; and
output instructions that cause at least one of said at least one processors to output, based on the identification information acquired, information of giving the user identified by the identification information a proposal to change the reservation to a reservation of the other, which has not been reserved by the user, of the first reservation frame and the second reservation frame.

14. The information processing apparatus according to claim 13, wherein:
the search instructions cause at least one of said at least one processors to search for the second reservation frame in which the number of users acquired is smaller than the minimum number of users.

15. The information processing apparatus according to claim 14, further comprising:
date and time acquisition instructions that cause at least one of said at least one processors to acquire, from a date and time storage that stores a date and time at which a user has reserved a reservation frame, a date and time at which a user has reserved the first reservation frame and a date and time at which a user has reserved the second reservation frame, and
wherein:
the identification information acquisition instructions cause at least one of said at least one processors to acquire the identification information of one of which the date and time acquired is the later of the user reserving the first reservation frame and the user reserving the second reservation frame.

16. The information processing apparatus according to claim 14, wherein:
the identification information acquisition instructions cause at least one of said at least one processors to acquire the identification information of the user reserving one in which a difference between the number of users having made the reservation and the minimum number of users is the larger, of the first reservation frame and the second reservation frame.

17. The information processing apparatus according to claim 15, wherein:
the identification information acquisition instructions cause at least one of said at least one processors to acquire the identification information of the user reserving one in which a difference between the number of users having made the reservation and the minimum number of users is the larger, of the first reservation frame and the second reservation frame.

18. The information processing apparatus according to claim 14, further comprising:
address acquisition instructions that cause at least one of said at least one processors to acquire, from an address storage that stores an address information indicating an address of a user, an address information of a user reserving the first reservation frame and an address information of a user reserving the second reservation frame; and
comparison instructions that cause at least one of said at least one processors to compare, based on addresses information acquired, accessibility with which the user reserving the first reservation frame reaches a place at which the event is to be held and accessibility with which the user reserving the second reservation frame reaches a place at which the event is to be held, and
wherein:
the identification information acquisition instructions cause at least one of said at least one processors to acquire, based on a result of comparison in accessibility, the identification information of the user having the easier accessibility, of the user reserving the first reservation frame and the user reserving the second reservation frame.

19. The information processing apparatus according to claim 15, further comprising:
address acquisition instructions that cause at least one of said at least one processors to acquire, from an address storage that stores an address information indicating an address of a user, an address information of a user reserving the first reservation frame and an address information of a user reserving the second reservation frame; and
comparison instructions that cause at least one of said at least one processors to compare, based on addresses information acquired, accessibility with which the user reserving the first reservation frame reaches a place at which the event is to be held and accessibility with which the user reserving the second reservation frame reaches a place at which the event is to be held, and
wherein:
the identification information acquisition instructions cause at least one of said at least one processors to acquire, based on a result of comparison in accessibility, the identification information of the user having the easier accessibility, of the user reserving the first reservation frame and the user reserving the second reservation frame.

20. The information processing apparatus according to claim 16, further comprising:
address acquisition instructions that cause at least one of said at least one processors to acquire, from an address storage that stores an address information indicating an address of a user, an address information of a user reserving the first reservation frame and an address information of a user reserving the second reservation frame; and
comparison instructions that cause at least one of said at least one processors to compare, based on addresses information acquired, accessibility with which the user reserving the first reservation frame reaches a place at which the event is to be held and accessibility with which the user reserving the second reservation frame reaches a place at which the event is to be held, and
wherein:
the identification information acquisition instructions cause at least one of said at least one processors to acquire, based on a result of comparison in accessibility, the identification information of the user having the easier accessibility, of the user reserving the first reservation frame and the user reserving the second reservation frame.

21. The information processing apparatus according to claim 17, further comprising:
address acquisition instructions that cause at least one of said at least one processors to acquire, from an address storage that stores an address information indicating an address of a user, an address information of a user reserving the first reservation frame and an address information of a user reserving the second reservation frame; and
comparison instructions that cause at least one of said at least one processors to compare, based on addresses information acquired, accessibility with which the user reserving the first reservation frame reaches a place at which the event is to be held and accessibility with which the user reserving the second reservation frame reaches a place at which the event is to be held, and
wherein:
the identification information acquisition instructions cause at least one of said at least one processors to acquire, based on a result of comparison in accessibility, the identification information of the user having the easier accessibility, of the user reserving the first reservation frame and the user reserving the second reservation frame.

22. The information processing apparatus according to claim 14, further comprising:
history acquisition instructions that cause at least one of said at least one processors to acquire, from a history storage that stores a history of operation by a user on a website in which a reservation frame available can be searched for, a history of a user reserving the first reservation frame and a history of a user reserving the second reservation frame; and
probability comparison instructions that cause at least one of said at least one processors to compare, based on histories acquired, a probability with which the user reserving the first reservation frame may change reservation and a probability with which the user reserving the second reservation frame may change reservation, and
wherein:
the identification information acquisition instructions cause at least one of said at least one processors to acquire, based on a result of comparison in probability, the identification information of the user having the higher probability, of the user reserving the first reservation frame and the user reserving the second reservation frame.

23. The information processing apparatus according to claim 15, further comprising:
history acquisition instructions that cause at least one of said at least one processors to acquire, from a history storage that stores a history of operation by a user on a website in which a reservation frame available can be searched for, a history of a user reserving the first reservation frame and a history of a user reserving the second reservation frame; and
probability comparison instructions that cause at least one of said at least one processors to compare, based on histories acquired, a probability with which the user reserving the first reservation frame may change reservation and a probability with which the user reserving the second reservation frame may change reservation, and
wherein:
the identification information acquisition instructions cause at least one of said at least one processors to acquire, based on a result of comparison in probability, the identification information of the user having the higher probability, of the user reserving the first reservation frame and the user reserving the second reservation frame.

24. The information processing apparatus according to claim 16, further comprising:
history acquisition instructions that cause at least one of said at least one processors to acquire, from a history storage that stores a history of operation by a user on a website in which a reservation frame available can be searched for, a history of a user reserving the first reservation frame and a history of a user reserving the second reservation frame; and
probability comparison instructions that cause at least one of said at least one processors to compare, based on histories acquired, a probability with which the user reserving the first reservation frame may change reservation and a probability with which the user reserving the second reservation frame may change reservation, and
wherein:
the identification information acquisition instructions cause at least one of said at least one processors to acquire, based on a result of comparison in probability, the identification information of the user having the higher probability, of the user reserving the first reservation frame and the user reserving the second reservation frame.

25. The information processing apparatus according to claim 17, further comprising:
history acquisition instructions that cause at least one of said at least one processors to acquire, from a history storage that stores a history of operation by a user on a website in which a reservation frame available can be searched for, a history of a user reserving the first reservation frame and a history of a user reserving the second reservation frame; and
probability comparison instructions that cause at least one of said at least one processors to compare, based on histories acquired, a probability with which the user reserving the first reservation frame may change reservation and a probability with which the user reserving the second reservation frame may change reservation, and
wherein:
the identification information acquisition instructions cause at least one of said at least one processors to acquire, based on a result of comparison in probability, the identification information of the user having the higher probability, of the user reserving the first reservation frame and the user reserving the second reservation frame.

26. The information processing apparatus according to claim 18, further comprising:
history acquisition instructions that cause at least one of said at least one processors to acquire, from a history storage that stores a history of operation by a user on a website in which a reservation frame available can be searched for, a history of a user reserving the first reservation frame and a history of a user reserving the second reservation frame; and
probability comparison instructions that cause at least one of said at least one processors to compare, based on histories acquired, a probability with which the user reserving the first reservation frame may change reservation and a probability with which the user reserving the second reservation frame may change reservation, and
wherein:
the identification information acquisition instructions cause at least one of said at least one processors to acquire, based on a result of comparison in probability, the identification information of the user having the higher probability, of the user reserving the first reservation frame and the user reserving the second reservation frame.

27. The information processing apparatus according to claim 13, wherein:
the search instructions cause at least one of said at least one processors to search for the second reservation frame in which the number of users acquired is equal to or larger than the minimum number of users; and
the identification information acquisition instructions cause at least one of said at least one processors to acquire identification information of a user reserving the first reservation frame.

28. An information processing apparatus comprising:
at least one memory operable to store program instructions;
at least one processor operable to access said memory, read said program instructions, and operate according to said program instructions, said program instructions comprising: number-of-users-acquisition instructions that cause at least one of said at least one processors to acquire, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
search instructions that cause at least one of said at least one processors to, when reservation frames which are reserved include a first reservation frame in which the number of users which is acquired is smaller than the minimum number of users, search for a second reservation frame in which the number of users acquired is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved;
identification information acquisition instructions that cause at least one of said at least one processors to, when the second reservation frame is found, acquire, from a storage that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and
identification information acquisition instructions that cause at least one of said at least one processors to, when the second reservation frame is found, acquire from a storage that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and
output instructions that cause at least one of said at least one processors to output, based on the identification information acquired, information of giving the users identified by the identification information a proposal to change the reservation to a reservation of the first reservation frame.

29. An information processing method to be executed by a computer, the method comprising:
acquiring, for each of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
when reservation frames which are reserved include a first reservation frame in which the number of users acquired is smaller than the minimum number of users, searching for a second reservation frame in which the number of users acquired is smaller than the maximum number of users and a total amount of the number of users reserving the second reservation frame and a number of at least part of the users reserving the first reservation frame is equal to or larger than the minimum number of users, from among the reservation frames which are reserved;
when the second reservation frame is found, acquiring from a storage that stores identification information for identifying a user in association with a reservation frame reserved by the user, identification information of a user reserving a reservation frame which is any one of the first reservation frame and the second reservation frame, the number of users of the any one acquired being smaller than the minimum number of users of the any one; and
outputting, based on the identification information acquired, information of giving the user identified by the identification information a proposal to change the reservation to a reservation of the other, which has not been reserved by the user, of the first reservation frame and the second reservation frame.

30. An information processing method to be executed by a computer comprising:
for each of a plurality of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
when reservation frames which are reserved include a first reservation frame in which the number of users which is acquired is smaller than the minimum number of users, searching for a second reservation frame in which the number of users acquired is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved;
when the second reservation frame is found, acquiring from a storage that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and
when the second reservation frame is found, acquiring from a storage that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and
outputting, based on the identification information acquired, information of giving the users identified by the identification information a proposal to change the reservation to a reservation of the first reservation frame.

31. A non-transitory computer readable medium storing thereon an information processing program, the information processing program causing a computer to:
acquire, for each of a plurality of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
when reservation frames which are reserved include a first reservation frame in which the number of users acquired is smaller than the minimum number of users, search for a second reservation frame in which the number of users acquired is smaller than the maximum number of users and a total amount of the number of users reserving the second reservation frame and a number of at least part of the users reserving the first reservation frame is equal to or larger than the minimum number of users, from among the reservation frames which are reserved;
when the second reservation frame is found, acquire from a storage that stores identification information for identifying a user in association with a reservation frame reserved by the user, identification information of a user reserving a reservation frame which is any one of the first reservation frame and the second reservation frame, the number of users of the any one acquired being smaller than the minimum number of users of the any one; and
output, based on the identification information acquired, information of giving the user identified by the identification information a proposal to change the reservation to a reservation of the other, which has not been reserved by the user, of the first reservation frame and the second reservation frame.

32. A non-transitory computer readable medium storing thereon an information processing program, the information processing program causing a computer to:
acquire, for each of a plurality of reservation frames, a number of users reserving a reservation frame in which a minimum number and a maximum number of users participating in an event are set, the event is to be held when the number of users having made the reservation is equal to or larger than the minimum number of users and the reservation is to be cancelled when the number of users is smaller than the minimum number of users;
when reservation frames which are reserved include a first reservation frame in which the number of users which is acquired is smaller than the minimum number of users, search for a second reservation frame in which the number of users acquired is more than the minimum number of users of the second reservation frame and a difference between the number of users reserving the second reservation frame and the minimum number of users of the second reservation frame is equal to or larger than a difference between the number of users reserving the first reservation frame and the minimum number of users of the first reservation frame, from among the reservation frames which are reserved;
when the second reservation frame is found, acquire from a storage that stores identification information for identifying a user in association with a reservation frame reserved by the user, identification information of users a number of whom is equal to or larger than the difference between the number of users reserving the first reservation frame and the minimum number of users of the first reservation frame, of users reserving the second reservation frame; and
when the second reservation frame is found, acquire from a storage that stores identification information for identifying a user in association with a reservation frame reserved by the user, identification information of a certain number of users included in users reserving the second reservation frame, the certain number being equal to or larger than the difference between the number of users reserving the first reservation frame and the minimum number of users of the first reservation frame; and
output, based on the identification information acquired, information of giving the users identified by the identification information a proposal to change the reservation to a reservation of the first reservation frame.
